(19) United States
(12) Patent Application Publication
(10) Pub. No.: US 2012/0227196 A1
(43) Pub. Date: Sep. 13, 2012

(54) Cleaning Compositions With Polyoxyalkylene-Oxide Capped Polyalkylene-Oxide-Polycarboxylate Graft Polymers

(76) Inventors: Koushik Mukherjee, Beijing (CN); Kenneth Nathan Price, Cincinnati, OH (US); Hemmi Akiko, Osaka (JP); Yoneda Atsuro, Osaka (JP); Nakanishi Sachiko, Osaka (JP); Sano Yuki, Osaka (JP)

(21) Appl. No.: 13/328,163

(22) Filed: Dec. 16, 2011

(30) Foreign Application Priority Data
Dec. 17, 2010 (WO) CN2010/079962

(51) Int. Cl. C11D 3/37; A47L 13/26; B65D 85/00; C08G 63/91

(52) U.S. Cl. 15/104.93; 510/400; 525/451; 206/524.7

(57) ABSTRACT

Cleaning compositions and laundry detergents comprising polyalkylene glycol-based graft polymers are disclosed. The polyalkylene glycol-based graft polymers are polyoxyalkylene-oxide capped polyalkylene-oxide-polycarboxylate graft polymers. The polyalkylene glycol-based graft polymer is a compound obtained by polymerizing a polyalkylene glycol-based compound and at least one carboxyl group-containing monomer in a polymerization mixture comprising from 60% to 95% by mass of the polyalkylene glycol-based compound and from 5% to 40% by mass of the carboxyl group-containing monomer. The cleaning compositions have high anti-soil redeposition ability in washing treatment and high solubility and compatibility with surfactants.

### TECHNICAL FIELD

The present invention relates to cleaning compositions, including especially fabric and home care cleaning compositions, and including especially laundry cleaning compositions. More specifically, the present invention relates to cleaning compositions comprising polyalkylene glycol-based graft polymers, particularly polyoxyalkylene-oxide capped polyalkylene-oxide-polycarboxylate graft polymers.

### BACKGROUND

Polyalkylene glycol-based polymers are useful polymers used in various industrial fields, and have high performance when used, for example, in dispersants, detergent compositions, and the like in aqueous environment. In the case that polyalkylene glycol-based polymers are used in aqueous environment, several influential factors such as the quality of water to be used and the interaction with other materials used in combination should be considered. Specifically, the hardness of water is different among countries or regions, and some of polyalkylene glycol-based polymers that produce various effects in aqueous environment with low water hardness may not produce sufficient effects in aqueous environment with high water hardness. When used, for example, in a detergent composition containing a surfactant, some polyalkylene glycol-based polymers may not have sufficient washing performance depending on the degree of the interaction with the surfactant.

Nowadays, there is a water saving trend in washing treatment (e.g., use of used water in bathtub for washing treatment) with recent growing concern of consumers for environmental problems. The use of used water in bathtub for washing treatment has disadvantages such as attachment of soil components in the water to fibers in washing treatment, and condensed hardening components in the water caused by heating the water several times. Therefore, the required level of performance of preventing soil components from reattaching to fibers (referred to as anti-soil redeposition ability) in washing treatment using water with a higher hardness is much higher than before.

### SUMMARY

Cleaning compositions according to embodiments described herein comprise a class of polyalkylene glycol-based graft polymers that provide improved cleaning benefits, even at lower surfactant levels or at reduced temperatures. Specific embodiments are directed to polyalkylene glycol-based graft polymers produced by polymerizing monomer materials including a polyalkylene glycol-based compound and having a specific average addition number of moles of C₃₋₄ oxyalkylene groups with a carboxyl group-containing monomer. Polymers derived from these monomers at specific ratios improves anti-soil redeposition ability and increases compatibility with surfactants, even in water with high hardness. The cleaning compositions according to embodiments described herein are suitable for use as a detergent additives.

Cleaning compositions according to example embodiments comprise one or more polyalkylene glycol-based graft polymer. The one or more polyalkylene glycol-based graft polymer is obtained by polymerizing in a polymerization mixture a polyalkylene glycol-based compound and a monomer material comprising at least one carboxyl group-containing monomer. The polymerization mixture comprises from 60% to 95% by mass of the polyalkylene glycol-based compound and from 5% to 40% by mass of the at least one carboxyl group-containing monomer, based on the total mass of the polyalkylene glycol-based compound and the monomer material in the polymerization mixture.

In preferred embodiments, the polyalkylene glycol-based compounds have formula (II):

R²Y—Xₚ—Z_{q}—OR¹)ᵣ (II).

where each R¹ is independently selected from the group consisting of —H, a C₆₋₂₀ aryl group, a linear or branched C₁₋₂₀ alkyl group, and a linear or branched alkenyl group. R² is selected from the group consisting of —H, a C₆₋₂₀ aryl group, a linear or branched C₁₋₂₀ alkyl group, and a linear or branched alkenyl group. The subscript r is an integer from 1 to 6 and represents the number of groups —Y—Xₚ—Z₁—OR¹ attached to a single group R². Each Y is —O—R³—. R³ is a C₂₋₆ alkylene group. Each X is —C(═O)—, and p is 0 or 1. In particular, each Z is an oxyalkylene group and q is from 9 to 150, with q representing an average addition number of moles of oxyalkylene groups. The unit Z_{q} represents a structure having formula (IV):

Z²₁Z¹ₙZ²ₘ (IV)

where each Z¹ is independently selected from C₃₋₄ oxyalkylene groups; each Z² is independently selected from a C₂₋₂₀ oxyalkylene groups; n is from 3 to 30; m is 0, 1, 2, or 3; and l+n+m=q. In especially preferred embodiments, each group Z¹ is an oxypropylene group and at least 80 mol. % of groups Z² are oxyethylene groups.

In preferred embodiments, the carboxyl group-containing monomer is selected from the group consisting of acrylic acid, maleic acid, salts of any of these, derivatives of any of these, and mixtures of any of these.

In example embodiments, cleaning compositions comprising the polyalkylene glycol-based graft polymers may further comprise a surfactant system containing one or more surfactant and, optionally, one or more co-surfactant.

In further example embodiments, the cleaning compositions may be incorporated into a cleaning implement comprising a nonwoven substrate.

These and other features, aspects, and advantages of the present invention will become better understood with reference to the following description and the appended claims

### DETAILED DESCRIPTION

Features and advantages of the invention now will be described with occasional reference to specific embodiments. However, the invention may be embodied in different forms and should not be construed as limited to the embodiments set forth herein. Rather, these embodiments are provided so that this disclosure will be thorough and complete and will fully convey the scope of the invention to those skilled in the art.

According to example embodiments, a cleaning composition comprises one or more polyalkylene glycol-based graft polymer formed from a plurality of structure units together defining a total mass of the polyalkyene glycol-based polymer. The one or more polyalkylene glycol-based graft polymer is obtained by polymerizing in a polymerization mixture a polyalkylene glycol-based compound, described below, and a monomer material comprising at least one carboxyl group-containing monomer, described below. The polymerization mixture comprises from 60% to 95% by mass of the polyalkylene glycol-based compound and from 5% to 40% by mass of the at least one carboxyl group-containing monomer, based on the total mass of the polyalkylene glycol-based compound and the monomer material in the polymerization mixture. Additional monomers, also described below, may be added to the polymerization mixture. As used herein, the term “polyalkylene glycol-based graft polymer” is intended to include graft polymers having a polyalkylene glycol chain, and the term “polyalkylene glycol-based monomer” is intended to include monomers having a polyalkylene glycol chain.

### Polyalkylene Glycol-Based Compound

The polyalkylene glycol-based graft polymer is obtained by polymerizing a polyalkylene glycol-based compound having in its most general form at least one structure unit represented by the formula (I):

Z¹ₙ (I)

at or near a molecular terminus and a monomer material including a carboxyl group-containing monomer in the mass ratio between the polyalkylene glycol-based compound and the carboxyl group-containing monomer of (95:5) to (60:40). In the formula (I), each Z¹ represents a C₃₋₄ oxyalkylene group and may be the same as or different from each other. The subscript n represents an average addition number of moles of the oxyalkylene groups (—Z¹—) and is from 3 to 30. In preferred embodiments, each Z¹ is an oxypropylene unit and, as such, the polyalkylene glycol-based compound in the preferred embodiments comprises a block of from 3 to 30 oxypropylene units.

Here, it is important that n is always not less than 3. With a structure in which n is not less than 3, the polyalkylene glycol-based graft polymer is likely to produce favorable interaction with soil components in the cleaning composition and to have improved anti-soil redeposition ability. On the other hand, if n is more than 30, the yield of the polyalkylene glycol-based graft polymer will be low, and therefore the anti-soil redeposition ability will be low also. More preferably, n is from 3 to 15, further more preferably from 3 to 10, and still further more preferably from 3 to 5.

The polyalkylene glycol-based compound, which is a material necessary for obtaining the polyalkylene glycol-based graft polymer, has one or more structure units represented by the formula (I). The polyalkylene glycol-based compound preferably has one or two structure units represented by the formula (I) in each molecule, and more preferably has exactly one structure unit represented by the formula (I) in each molecule.

The polyalkylene glycol-based compound preferably has a C₃₋₄ oxyalkylene structure unit at or near a molecular terminus, as defined below, and particularly preferably has the structure unit with formula (I) at a molecular terminus, as defined below. With the structure unit of formula (I) at or near a terminal of a molecule, the polyalkylene glycol-based graft polymer is likely to result in cleaning compositions that adsorb well on soil particles and have improved anti-soil redeposition ability.

Though the polyalkylene glycol-based compound is not particularly limited, provided that it has the structure unit represented by the formula (I), in preferred embodiments the polyalkylene glycol-based compound has the general structure represented by formula (II):

R²Y—Xₚ—Z_{q}—OR¹)ᵣ (II).

In formula (II), R¹ and R² each represent —H, a C₆₋₂₀ aryl, a linear or branched C₁₋₂₀ alkyl group, or a linear or branched C₁₋₂₀ alkenyl group. The subscript r is from 1 to 6 and represents the number of groups R¹ in the molecular structure. Each group of R¹ may be the same as or different from each other. Groups X and Y are described in detail below, and p is 0 or 1. Group Z represents an oxyalkylene group, such that q is an average addition number of moles of the oxyalkylene groups. The subscript q is from 9 to 150; and the subscript r is an integer of 1 to 6. As described in greater detail below, Z_{q} includes a structure having, on average, 3 to 30 C₃₋₄ oxyalkylene groups. As such Z_{q} includes the at least one structure unit having formula (I), described above.

In the formula (II), each R¹ is preferably —H, a C₆₋₁₈ aryl group, a C₁₋₁₈ alkyl group, or a C₁₋₁₈ alkenyl group; more preferably —H, a C₆₋₁₂ aryl, a C₁₋₁₂ alkyl group, or a C₁₋₁₂ alkenyl group; further more preferably —H or a C₆ aryl group, a C₁₋₁₂ alkyl group, or a C₁₋₁₂ alkenyl group. Most preferably, R¹ is —H. When each group R¹ is selected from these preferable examples, the anti-soil redeposition ability of the cleaning composition comprising the at least one polyalkylene glycol-based graft polymer may be improved. In addition, the polyalkylene glycol-based compound itself may have a viscosity suitable for polymerization, so as to facilitate the polymerization.

In the formula (II), R² is more preferably —H or a C₁₋₃ alkyl group. With these structures a as group R², the structure represented by the formula (II) will suitably adsorb on soil matters and the like when the polyalkylene glycol-based graft polymer is used in the cleaning composition. The group R² is particularly preferably a C₁₋₃ alkyl group, and more particularly preferably a methyl group or an ethyl group. With these structures, the molecular structure of the polyalkylene glycol-based graft polymer may be suitably controlled, and the polyalkylene glycol-based graft polymer will suitably adsorb on soil matters and the like when contained in the cleaning composition.

Described in general terms, the polyalkylene glycol-based graft polymer is a graft polymer in which polymer chains derived from the carboxyl group-containing monomer are linked to carbon atoms in the polyoxyalkylene chain of the polyalkylene glycol-based compound. The polyalkylene glycol-based graft polymer is preferably free from aromatic rings in the molecular structure. This is because, if the polyalkylene glycol-based graft polymer has aromatic rings, the aromatic rings will become a part of harmful substances when the polyalkylene glycol-based graft polymer is released to the natural environment and subsequently decomposes. As such, R¹ and R² are preferably —H, an alkyl group, or an alkenyl group. To ensure comparatively low viscosity and good handling, R¹ and R² preferably are —H or a secondary alkyl or alkenyl group.

Examples of suitable alkyl groups include, but are not limited to, methyl groups, ethyl groups, propyl groups, butyl groups, 2-ethylhexyl groups, octyl groups, nonyl groups, decyl groups, undecyl groups, dodecyl groups, tridecyl groups, tetradecyl groups, pentadecyl groups, hexadecyl groups, heptadecyl groups, octadecyl groups, nonadecyl groups, and icosyl groups. Examples of suitable alkenyl groups include octylene groups, nonylene groups, decylene groups, undecylene groups, dodecylene groups, tridecylene groups, tetradecylene groups, pentadecylene groups, hexadecylene groups, heptadecylene groups, octadecylene groups, nonadecylene groups, and icosylene groups. Among these, R¹ and R² are each preferably selected from 2-ethylhexyl groups, dodecyl groups, tridecyl groups, tetradecyl groups, dodecylene groups, tridecylene groups, and tetradecylene groups; and more preferably from 2-ethylhexyl groups, dodecyl groups, tridecyl groups, and tetradecyl groups. To avoid gelation of the polymer, R¹ and R² are more preferably group other than alkenyl groups. Even so, if R¹ or R² is an alkenyl group, most preferably the alkenyl group is a C₄ or higher alkenyl group.

Examples of suitable aryl groups include, but are not limited to phenyl groups, phenethyl groups, 2,3- and 2,4-xylyl groups, mesityl groups, naphthyl groups, anthryl groups, phenanthryl groups, biphenyl groups, trithyl groups, and pyrenyl groups. Among these, phenethyl groups, 2,3- and 2,4-xylyl groups, and naphthyl groups are preferable, and phenethyl groups and 2,3- and 2,4-xylyl groups are more preferable. To avoid impurities of low-molecular weight aromatic compounds, it is most preferred that R¹ and R² both are not aryl groups.

In the formula (II), X is 1,4-phenylene or —C(═O)—, as shown in the structures below:

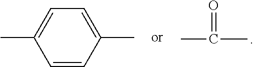

In the formula (II), the subscript p is 0 or 1. As described above, the polyalkylene glycol-based graft polymer is preferably free from aromatic rings. Accordingly, when p is 1, X is preferably a carbonyl group. However, p is more preferably 0 (i.e., X is not present).

In the formula (II), Y is selected from one of the structures shown below:

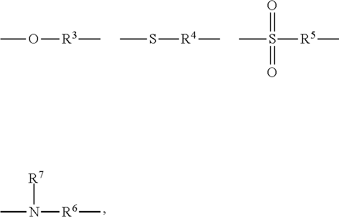

wherein R³, R⁴, R⁵, and R⁶ independently represent a C₂₋₆ alkylene group, preferably a C₂₋₄ alkylene group, more preferably a C₂₋₃ alkylene group, and further more preferably a C₂ alkylene group. The group R⁷ represents —H or a group having the formula (III):

—R⁸—Z_{q}—R⁹ (III)

where R⁸ is a C₂₋₆ alkylene group, preferably a C₂₋₄ alkylene group, more preferably a C₂₋₃ alkylene group, and further more preferably a C₂ alkylene group; R⁹ represents —H, a C₆₋₂₀ aryl group, a C₁₋₂₀ alkyl group, or a C₁₋₂₀ alkenyl group; and Z and q are defined as in the formula (II), above. To improve the anti-soil redeposition ability of cleaning compositions comprising the alkylene glycol-based graft polymer, Y is preferably —O—R³—.

In the formula (II), Z represents an oxyalkylene group. The term Z_{q} in the formula (II) includes a structure having, on average, from 3 to 30 C₃₋₄ oxyalkylene groups. The number of carbon atoms in oxyalkylene groups other than the C₃₋₄ oxyalkylene groups is from 2 to 20, preferably from 2 to 15, more preferably from 2 to 10, further more preferably from 2 to 5, still further more preferably 2 or 3, and particularly preferably 2. Examples of the oxyalkylene groups include groups derived from compounds such as ethylene oxide (EO), propylene oxide (PO), isobutylene oxide, 1-butene oxide, 2-butene oxide, trimethylethylene oxide, tetramethylene oxide, tetramethylethylene oxide, butadiene monoxide, octylene oxide, styrene oxide, and 1,1-diphenylethylene oxide. Among these, Z is preferably a group derived from EO or PO (i.e., an oxyethylene group or an oxypropylene group), and more preferably an oxyethylene group. All of the groups Z may be of the same structure or may be of two or more different structures.

In the formula (II), the subscript q is an average addition number of moles of the oxyalkylene groups (Z) and is from 9 to 150, preferably from 9 to 99, more preferably from 9 to 80, further more preferably from 12 to 70, and still further more preferably from 15 to 60. If q is less than 9, the polymerization may not proceed. In this case, the water solubility of the polymer is low, which in turn may lead to low anti-soil redeposition ability in the cleaning composition. If q is more than 150, the viscosity may be high and the polymerization may not proceed. Even if the polymerization proceeds, the resulting polymer may not be suitable as a builder for a cleaning composition, for example. With larger q, the yield of the polyalkylene glycol-based graft polymer will be higher. It is believed that this is because the amount of unreacted polyalkylene glycol-based compound will be smaller.

Preferably, the structure (Z_{q}) constituted by the oxyalkylene groups in the formula (II) is composed mainly of oxyethylene groups (—O—CH₂—CH₂—). As used here, the term “composed mainly of oxyethylene groups” means that oxyethylene groups constitute not less than half of all the oxyalkylene groups other than the C₃₋₄ oxyalkylene groups. It is believed that such as structure produces advantageous effects in that the polymerization smoothly proceeds in the production process; and the water solubility and anti-soil redeposition ability of the cleaning composition are improved.

As used herein, the term “oxyethylene ratio” refers to the number of oxyalkylene groups (expressed as a mol. %) in a group Z_{q} that are oxyethylene, based on the total number of oxyalkylene units in the group Z_{q} that are not C₃₋₄ oxyalkylene units. Thus, when Z_{q} in the formula (II) is composed mainly of oxyethylene groups, the corresponding oxyethylene ratio is from 50 mol. % to 100 mol. %. With an oxyethylene ratio of less than 50 mol. %, the group Z_{q} may have low hydrophilicity as a part of the polyalkylene glycol-based graft polymer. The oxyethylene ratio is more preferably at least 60 mol. %, further more preferably at least 70 mol %, and still further more preferably at least 75 mol %, and particularly preferably at least 80 mol %.

In the formula (II), the subscript r is an integer from 1 to 6. When r is not less than 2, the polyalkylene glycol-based compound represented by the formula (II) has a structure in which each of the parenthesized groups in the formula (II) is linked to a carbon atom in the group R². This does not mean that the polyalkylene glycol-based compound includes a repeating structure having the parenthesized groups in the formula (II) as repeating units. Each of the parenthesized groups of the formula (II) may be the same as or different from each other, and r is preferably from 1 to 4, more preferably from 1 or 2, and further more preferably equal to 1.

As described above, the polyalkylene glycol-based compound preferably includes the structure represented by the formula (I) at or near a molecular terminus, and particularly preferably at a molecular terminus. The term “at or near a molecular terminus” is best illustrated by considering, for example, the structure component —Z_{q}—OR¹ in the formula (II), when the structure component can be represented by formula (IV):

Z²₁Z¹ₙZ²ₘ—OR¹ (IV).

In the formula (IV), R¹ represents —H, a C₆₋₂₀ aryl group, a C₁₋₂₀ alkyl group, or a C₁₋₂₀ alkenyl group; Z¹ represents a C₃₋₄ oxyalkylene group; Z² represents a C₂₋₂₀ oxyalkylene group; n is an average addition number of moles of the oxyalkylene groups (—Z¹—) and is from 3 to 30; the sum of l+n+m equals q in formula (II), where q is from 9 to 150; and m is preferably 0.

In formula (IV), a “molecular terminus” is defined by the group R¹, which may be —H, a C₆₋₂₀ aryl, a linear or branched C₁₋₂₀ alkyl group, or a linear or branched C₁₋₂₀ alkenyl group, as defined above, and preferably may be —H or a C₁₋₆ group. Thus, to represent when the polyalkylene glycol-based compound has the structure unit represented by the formula (I) at a molecular terminus, the subscript m in formula (IV) is 0 and R¹ is —H. To represent when the polyalkylene glycol-based compound has the structure unit represented by the formula (I) near molecular terminus, in formula (IV) either (i) subscript m is from 1 to 3, or (ii) subscript m is 0 and R¹ is not —H.

In especially preferred embodiments of the cleaning composition, the group Z_{q} in the polyalkylene glycol-based compound of formula (II) can be expressed according to formula (IV).

The polyalkylene glycol-based compound may be a commercially available product or may be prepared. The polyalkylene glycol-based compound can be prepared by adding the above-described alkylene oxides to compounds including a structure to be a hydrocarbon moiety of the polyalkylene glycol-based compound such as alcohols, esters, amines, amides, thiols, and sulfonic acids, for example. Example preparation techniques include, but are not limited to: (1) anionic polymerization using strong alkalis such as hydroxides of alkali metals, alkoxides, or alkylamines as basic catalysts; (2) cationic polymerization using halides of metals or semimetals, mineral acids, or acetic acid as catalysts; and (3) coordination polymerization using in combination alkaline-earth metals, Lewis acids, alkoxides of metals such as aluminum, iron, and zinc, and the like. Examples of the polyalkylene glycol-based compound include polyethylene glycol, methoxy polyethylene glycol, butoxy polyethylene glycol, and phenoxy polyethylene glycol.

### Carboxyl Group-Containing Monomer

In the polyalkylene glycol-based graft polymers of the cleaning compositions, typically one or more carboxyl group-containing monomer is graft polymerized to form a chain that is graft polymerized onto a carbon atom in the polyoxyalkylene chain of the polyalkylene glycol-based graft polymer. The one or more carboxyl group-containing monomers used to produce the polyalkylene glycol-based graft polymer may all have same structure or may have different structures. The carboxyl group-containing monomer is a monomer comprising (1) an unsaturated double bond; and (2) a carboxyl group and/or a carboxylate salt.

Specific examples of carboxyl group-containing monomers include, but are not limited to, unsaturated monocarboxylic acids such as acrylic acid, methacrylic acid, crotonic acid, α-hydroxyl acrylic acid, α-hydroxyl methylacrylic acid, derivatives of these monomers, and salts of these monomers; and unsaturated dicarboxylic acids such as itaconic acid, fumaric acid, maleic acid, citraconic acid, and 2-methylene glutaric acid, and salts thereof. Any unsaturated dicarboxylic acid-based monomer may be used, provided that it contains a single unsaturated group and two carboxyl groups in the molecular structure. Suitable examples of dicarboxylic acid-based carboxyl group-containing monomers include, but are not limited to, maleic acid, itaconic acid, citraconic acid, and fumaric acid; monovalent metal salts, divalent metal salts, ammonium salts, and organic ammonium salts (organic amine salts) of the above acids; and anhydrides of the acids or salts.

Among these examples, the carboxyl group-containing monomer is preferably acrylic acid, an acrylate, maleic acid, or a maleate, because it is believed these may improve the anti-soil redeposition ability of the resulting polymer. More preferably, the carboxyl group-containing monomer consists essentially of acrylic acid and/or acrylate salts.

Suitable examples of salts of unsaturated monocarboxylic acids and unsaturated dicarboxylic acids include metal salts, ammonium salts, and organic amine salts. Examples of metal salts include monovalent alkali metal salts such as sodium salts, lithium salts, and potassium salts; alkaline-earth metal salts such as magnesium salts and calcium salts; and salts of other metals such as aluminum salts and iron salts. Examples of the organic amine salts include alkanolamine salts such as monoethanolamine salts, diethanolamine salts, and triethanolamine salts; alkylamine salts such as monoethylamine salts, diethylamine salts, and triethylamine salts; organic amine salts such as polyamines including ethylenediamine salts and triethylenediamine salts Ammonium salts, sodium salts, and potassium salts are preferable among these because they are believed to improve the anti-soil redeposition ability of the resulting polymer. Sodium salts are more preferable.

Further examples of the carboxyl group-containing monomer include half esters of unsaturated dicarboxylic acid-based monomers and C₁₋₂₂ alcohols, half amides of unsaturated dicarboxylic acid-based monomers and C₁₋₂₂ amines, half esters of unsaturated dicarboxylic acid-based monomers and C₂₋₄ glycols, and half amides of maleamic acid and C₂₋₄ glycols.

### Additional Monomer(s)

In addition to the polyalkylene glycol-based compound(s) and the carboxyl group-containing monomer(s) described above, one or more additional monomer(s) may be used to produce the polyalkylene glycol-based graft polymer. The additional monomer(s) are not particularly limited and are appropriately selected to provide desired effects.

Specific examples of the additional monomer(s) include, but are not limited to: sulfonic acid group-containing monomers such as vinylsulfonic acid, (meth)allyl sulfonic acid, isoprenesulfonic acid, 3-allyloxy-2-hydroxypropanesulfonic acid, and acrylamido-2-methylpropanesulfonic acid, and salts of these; dialkylaminoalkyl(meth)acrylates such as dimethylaminoethyl acrylate, dimethylaminoethyl methacrylate, and dimethylaminopropyl acrylate; dialkylaminoalkyl(meth)acrylamides such as dimethylaminoethyl acrylamide, dimethylaminoethyl methacrylamide, and dimethylaminopropyl acrylamide; amino group-containing monomers such as vinylimidazole, vinylpyridine, diallylalkylamines, and diallyl amine, and quaternized compounds of these; N-vinyl monomers such as N-vinylpyrrolidone, N-vinylformamide, N-vinylacetamide, N-vinyl-N-methylformamide, N-vinyl-N-methylacetamide, and N-vinyloxazolidone; amide-containing monomers such as (meth)acrylamide, N,N-dimethylacrylamide, and N-isopropylacrylamide; hydroxyl group-containing monomers such as (meth)allyl alcohol and isoprenol; alkyl(meth)acrylate-based monomers such as butyl(meth)acrylate, 2-ethylhexyl(meth)acrylate, and dodecyl(meth)acrylate; hydroxyalkyl(meth)acrylate-based monomers such as hydroxyethyl(meth)acrylate, 2-hydroxyethyl(meth)acrylate, hydroxybutyl(meth)acrylate, 2-hydroxybutyl(meth)acrylate, 4-hydroxybutyl(meth)acrylate, α-hydroxymethylethyl(meth)acrylate, hydroxypentyl(meth)acrylate, hydroxyneopentyl(meth)acrylate, and hydroxyhexyl(meth)acrylate; vinylaryl monomers such as styrene, indene, and vinylaniline; and other monomers such as isobutylene, and vinyl acetate.

The quaternized compounds can be obtained by a reaction between the amino group-containing monomers and common quaternizing agents. Examples of the quaternizing agents include alkyl halides and dialkyl sulfates. The exemplified salts include chlorides and organic acid salts.

When optional additional monomer(s) are used to produce the polyalkylene glycol-based graft polymer, the additional monomers may all have the same structure or may have two or more different structures.

The carboxyl group-containing monomer and additional monomer(s) may be arranged in the polyalkylene glycol-based graft polymer in any manner such as, for example, randomly or in blocks. Alternatively, the carboxyl group-containing monomer and additional monomer(s) may separately form different polymerization chains added to the polyalkylene glycol-based graft polymer. Hereinafter, the carboxyl group-containing monomer and the additional monomer(s) are together referred to as a “monomer material.”

The ratio of the carboxyl group-containing monomer in the monomer material is preferably from 80% mol. % to 100 mol. %, more preferably from 90 mol. % to 100 mol. %, further more preferably from 95 mol. % to 100 mol %, and still further more preferably 100 mol. %, based on 100 mol % of all the monomers (the carboxyl group-containing monomer and the additional monomer(s)). At ratios within the above range, the anti-soil redeposition ability of the polyalkylene glycol-based graft polymer is likely to improve. The ratio of the additional monomer(s) in the monomer material is preferably from greater than 0 mol. % (i.e., at least one additional monomer is added, but the overall percentage may be negligible) to 20 mol %, more preferably from greater than 0 mol. % to 10 mol %, further more preferably from greater than 0 mol. % to 5 mol % of the monomers in the monomer material are additional monomers. Still further more preferably, 0 mol. % of the monomers (i.e., none of the monomers) in the monomer material are additional monomers.

The polyalkylene glycol-based graft polymer may prepared from the polyalkylene glycol-based compound and the monomer material, wherein the monomer material includes the carboxyl group-containing monomer and the optional additional monomer(s). Typically, the carboxyl group-containing monomer makes up from 5% to 40% by mass of the polyalkylene glycol-based graft polymer, where 100% represents the total amount of the carboxyl group-containing monomer and the polyalkylene glycol-based compound.

The polyalkylene glycol-based graft polymer may be prepared by polymerizing the polyalkylene glycol-based compound and the monomer material, wherein the monomer material consists essentially of carboxyl group-containing monomer. In such preparations, the mass ratio of the polyalkylene glycol-based compound to the carboxyl group-containing monomer may be from (95:5) to (60:40). The carboxyl group-containing monomer more preferably accounts for from 6% to 30% by mass, further more preferably from 10% to 25% by mass, and still further more preferably from 15% to 22% by mass, of the total amount of the carboxyl group-containing monomer and the polyalkylene glycol-based compound that together compose the polyalkylene glycol-based graft polymer. At ratios within the above range, the anti-soil redeposition ability of the polyalkylene glycol-based graft polymer may be improved.

The monomer material preferably accounts for from 5% to 40% by mass, more preferably from 6% to 30% by mass, further more preferably from 10% to 25% by mass, and still further more preferably from 15% to 22% by mass, of the total amount of the monomer material and the polyalkylene glycol-based compound (also referred to as all the materials) that together compose the polyalkylene glycol-based graft polymer.

The mass ratios (% by mass) of acid group-containing monomers, including the carboxyl group-containing monomer, to all the materials are determined by treating the acid group-containing monomers as the respective corresponding acids. For example, in the case of sodium acrylate, the mass ratio of the corresponding acid, acrylic acid, is calculated. The mass ratios (% by mass) of structure units derived from the acid group-containing monomers to all the structure units derived from all the materials are calculated analogously.

The polyalkylene glycol-based graft polymers advantageously comprise a polyalkylene oxide backbone in the form of a mixed polyalkylene oxide system providing hydrophilicity and hydrophobicity in defined degrees. For example, preferred embodiments of the polyalkylene glycol-based graft polymer are polymers comprising a main chain containing a polyethylene oxide (PEO) capped with a poly- or an oligo-propylene oxide moiety on one end, and further comprising acrylic-acid tentacles grafted onto the PEO-containing main chain. For such a polyalkylene glycol-based graft polymer, without wishing to be bound by theory, it is believed that the polypropylene oxide (PPO) capping unit provides a type of hydrophobic capping group for PEG/polycarboxylate graft polymers, wherein the degree of hydrophobicity of the capping unit is less than that of simple alkyl or aryl groups. Furthermore, it is believed that the PPO capping unit may provide a degree of steric bulkiness and hydrogen-bond acceptor properties useful for soil, fabric, and surfactant interactions. In one mode of interaction, the polycarboxylate moieties may bind to calcium either in solution or as bridging units between clay platelets, with the PEO-PPO backbone extended into water solution and terminally interacting with surfactant monomers or micelles. In another mode of interaction, the PPO capping group may anchor the polymer onto soil, fabric, or surfactant micelle surfaces, with the PEG/polycarboxylate main chain acting to provide charge stabilization. The charge stabilization may provide a fabric with negative charges (presented to bulk solution), such that the negative charges may act as soil repellancy motifs. The charge stabilization may increase the suspendability of clay and other particulate matter.

Acid group-containing unsaturated monomers in a composition containing the polyalkylene glycol-based composition, described below, can be quantified by liquid chromatography under the following conditions:

Measuring device: L-7000 series (product of Hitachi Ltd.)

Detector: UV detector, L-7400 (product of Hitachi Ltd.)

Column: SHODEX RSpak DE-413 (product of Showa Denko K. K.)

Temperature: 40.0° C.

Eluant: 0.1% phosphoric acid aqueous solution

Flow velocity 1.0 mL/min

The weight-average molecular weight (M_{w}) of the polyalkylene glycol-based graft polymer is not particularly limited and can be appropriately determined, considering desired performance such as desired performance for a detergent builder. Specifically, the weight-average molecular weight of the polyalkylene glycol-based graft polymer is preferably 300 to 50,000, more preferably 500 to 30,000, further more preferably 1000 to 20,000, and still further more preferably 1000 to 5000. With too high weight-average molecular weight, the polyalkylene glycol-based graft polymer will have too high viscosity and therefore will be difficult to handle. With too low weight-average molecular weight, the anti-soil redeposition ability may not be provided. The weight-average molecular weight of the polyalkylene glycol-based graft polymer used herein is determined by the technique described in Examples below.

The number-average molecular weight (M_{N}) of the polyalkylene glycol-based graft polymer is not particularly limited and can be appropriately determined, considering desired performance such as desired performance for a detergent builder. Specifically, the number-average molecular weight of the polyalkylene glycol-based graft polymer is preferably 300 to 25,000, more preferably 350 to 15,000, further more preferably 500 to 10,000, and still further more preferably 500 to 3000. With too high number-average molecular weight, the polyalkylene glycol-based graft polymer will have high viscosity and therefore will be difficult to handle. With too low number-average molecular weight, the anti-soil redeposition ability may not be provided. The number-average molecular weight of the polyalkylene glycol-based graft polymer used herein is determined by the technique with the device under the conditions described in Examples below.

The polyalkylene glycol-based graft polymers have high anti-soil redeposition ability. The anti-soil redeposition ratio of the polyalkylene glycol-based graft polymer is preferably not less than 55%, more preferably not less than 60%, and further more preferably not less than 65%. The anti-soil redeposition ratio can be measured by the procedure described in Examples below.

### Polyalkylene Glycol-Based Graft Polymer Composition

The polyalkylene glycol-based graft polymer may be present with other component(s) in a polyalkylene glycol-based graft polymer composition. Examples of components other than the polyalkylene glycol-based graft polymer include graft polymers produced by graft polymerization of the polyalkylene glycol-based compound with the carboxyl group-containing monomer and/or the other monomer(s), unreacted polyalkylene glycol-based compound, by-products derived from the carboxyl group-containing monomer, the carboxyl group-containing monomer, unreacted polymerization initiators, decomposed compounds of polymerization initiators, and polymers of the carboxyl group-containing monomer.

Hereinafter, such a composition containing the polyalkylene glycol-based graft polymer is referred to as a polyalkylene glycol-based graft polymer composition.

The mass ratio between structure units derived from the polyalkylene glycol-based compound and structure units derived from the carboxyl group-containing monomer in the polymer composition is preferably (95:5) to (60:40), more preferably (94:6) to (70:30), further more preferably (92:8) to (75:25), and still further more preferably (90:10) to (80:20). If the amount of the structure units derived from the carboxyl group-containing monomer is too small, the anti-soil redeposition ability is likely to be low. If the amount of the structure units derived from the carboxyl group-containing monomer is too large, the resulting composition tends to contain large amounts of impurities derived from the carboxyl group-containing monomer. In this case, the temporal stability and detergent performance of the composition are likely to be low. Accordingly, the ratio is preferably within the above range.

The “structure units derived from the polyalkylene glycol-based compound” are intended to include structure units derived from the polyalkylene glycol-based compound in the polyalkylene glycol-based graft polymer and unreacted polyalkylene glycol-based compound (and structure units derived from the polyalkylene glycol-based compound in by-products if they are produced). Namely, the total mass of the structure units derived from the polyalkylene glycol-based compound is equal to the mass of the polyalkylene glycol-based compound used in the polymerization. The “structure units derived from carboxyl group-containing monomer” are similarly intended to include structure units derived from the carboxyl group-containing monomer in the polyalkylene glycol-based graft polymer, unreacted carboxyl group-containing monomer, structure units in polymers of the carboxyl group-containing monomer and structure units in polymers of the carboxyl group-containing monomer and other monomers. The total mass of the structure units derived from the carboxyl group-containing monomer is equal to the mass of the carboxyl group-containing monomer used in the polymerization. These structure units can be analyzed by techniques such as NMR.

Specific polymerization initiator(s) may be used for the production of the polyalkylene glycol-based graft polymer to reduce unreacted polyalkylene glycol-based compound. Specifically, the amount of reacted polyoxyalkylene glycol-based compound is preferably 45 parts to 100 parts by mass, more preferably 50 parts to 100 parts by mass, and further more preferably 55 parts to 100 parts by mass, based on 100 parts by mass of the total of reacted polyoxyalkylene glycol-based compound and unreacted polyoxyalkylene glycol-based compound (100 parts by mass of the polyoxyalkylene glycol-based compound added in the reaction system).

The amount of reacted polyoxyalkylene glycol-based compound can be calculated from the amount the unreacted polyoxyalkylene glycol-based compound that can be quantified by high-speed liquid chromatography under the following conditions:

Measuring device: 8020 series (product of Tosoh Corp.)

Column: CAPCELL PAK C1 UG120 (product of Shiseido Co., Ltd.)

Temperature: 40.0° C.

Eluant: dodecahydrate solution of 10 mmol/L Na₂HPO₄ (pH 7 (controlled with phosphoric acid))/acetonitrile=45:55 (volume ratio)

Flow velocity: 1.0 mL/min

Detector: RI, UV (detection wavelength: 215 nm).

The “polymer composition” used herein is not particularly limited and, in view of production efficiency, is preferably produced without steps such as a purification step for removing impurities. The polymer composition has a low remaining polyoxyalkylene glycol-based compound content and a high polyalkylene glycol-based graft polymer (graft compound) content. Owing to these properties, the polymer composition effectively improves the anti-soil redeposition ability when used in a detergent. The polymer composition may be diluted with a small amount of water (1% to 400% by mass of water to the composition) after the polymerization step to improve the handleability, and such diluted compositions are also included in the polymer composition. The yield of the graft compound can be determined from the value calculated by the graft compound yield calculation method, described below.

The polymer compositions may contain at least one of the compounds (A), (B), and/or (C), represented by the formulas below:

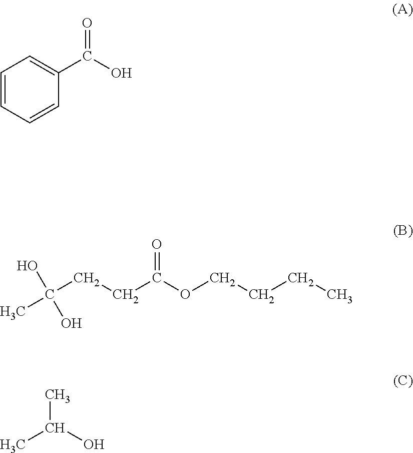

These compounds may be derived from a polymerization initiator.

Compounds (A), (B), and (C) may be decomposition products of polymerization initiators that are suitably used in the production of the polyalkylene glycol-based graft polymer. For example, if tert-butylperoxy benzoate (hereinafter, also referred to as PBZ) is used as a polymerization initiator, the resulting polymer composition may contain the compound (A). When n-butyl-4,4-di(tert-butylperoxy)valerate (hereinafter, also referred to as PHV) is used as a polymerization initiator, the resulting polymer composition may contain the compound (B). When tert-butylperoxyisopropyl monocarbonate (hereinafter, also referred to as PBI) is used as a polymerization initiator, the resulting polymer composition may contain the compound (C).

Any one of the polymerization initiators may be used alone, or two or more of the polymerization initiators may be used in combination. Therefore, the polymer composition may contain two or more of the compounds (A), (B), and/or (C).

The amounts of the compounds (A), (B), and/or (C) in the polymer composition preferably constitutes from 0.01% to 2.0% by mass of the polymer composition (based on solids content). The presence of the compounds (A), (B), and/or (C) in an amount within the above range indicates that the polymerization initiator(s) are used in an appropriate amount, and that the resulting composition contains the high-performance polyalkylene glycol-based graft polymer.

The amount of the compounds (A), (B), and/or (C) means the total amount of the compounds (A), (B), and/or (C) when two or more of the compounds (A), (B), and/or (C) are present. The amount of the compounds (A), (B), and/or (C) in the polymer composition may be determined by high-speed liquid chromatography under the following conditions:

Measuring device: 8020 series (product of Tosoh Corp.)

Column: CAPCELL PAK C1 UG120 (product of Shiseido Co., Ltd.)

Temperature: 40.0° C.

Eluant (compounds 1 and 3): dodecahydrate solution of 10 mmol/L Na₂HPO₄ (pH 7 (controlled with phosphoric acid))/acetonitrile=90:10 (volume ratio)

Eluant (compound 2): dodecahydrate solution of 10 mmol/L Na₂HPO₄ (pH 7 (controlled with phosphoric acid))/acetonitrile=30:70 (volume ratio)

Flow velocity 1.0 mL/min

Detector: RI, UV (detection wavelength: 215 nm)

The amount of the compounds (A), (B), and/or (C) in the polymer composition is preferably 0.3 parts to 20 parts by mass, more preferably 1 part to 10 parts by mass, and further more preferably 1 part to 5 parts by mass, based on 100 parts by mass of the carboxyl group-containing monomer used as a material. The presence of the compounds (A), (B), and/or (C) in an amount within the above range means that the polymerization initiator(s) are used in an appropriate amount, and that the composition contains the polyalkylene glycol-based graft polymer with high anti-soil redeposition ability.

### Preparation Process

The polyalkylene glycol-based graft polymer is prepared by a production process including a step of polymerizing the polyalkylene glycol-based compound and the monomer material including the carboxyl group-containing monomer under the condition in which the mass ratio between the polyalkylene glycol-based compound and the carboxyl group-containing monomer is from (95:5) to (60:40). The production process may include other steps, provided that it includes the above polymerization step.

The polymer composition can be produced by appropriately relying on the common technical knowledge in the art. The polymers are preferably polymerized substantially by bulk polymerization. Specifically, the polymerization is carried out in a graft polymerization reaction system in which the solvent constitutes not more than 10% by mass of the whole reaction system. A specific procedure in the polymerization method is not particularly limited. Specifically, the polymerization may be performed by appropriately relying on the common technical knowledge relating to bulk polymerization, and optionally, a modified method may be performed. It is preferable to produce the graft compound substantially by bulk polymerization because the yield of the graft compound thus produced is higher compared to the case where aqueous solution polymerization is used, and the anti-soil redeposition ability may be improved.

### Uses of Polyalkylene Glycol-Based Graft Polymers and Polymer Compositions

The polyalkylene glycol-based graft polymer (or polyalkylene glycol-based graft polymer composition) can be used as a coagulant, flocculating agent, printing ink, adhesive, soil control (modification) agent, fire retardant, skin care agent, hair care agent, additive for shampoos, hair sprays, soaps, and cosmetics, anion exchange resin, dye mordant, and auxiliary agent for fibers and photographic films, pigment spreader for paper making, paper reinforcing agent, emulsifier, preservative, softening agent for textiles and paper, additive for lubricants, water treatment agent, fiber treating agent, dispersant, additive for detergents, scale control agent (scale depressant), metal ion sealing agent, viscosity improver, binder of any type, emulsifier, and the like. When used as a detergent builder, the polyalkylene glycol-based graft polymer (or polyalkylene glycol-based graft polymer composition) can be added to detergents for various usages such as detergents for clothes, tableware, cleaning, hair, bodies, toothbrushing, and vehicles.

### Fiber Treating Agent

The polyalkylene glycol-based graft polymer (or polyalkylene glycol-based graft polymer composition) can be used in fiber treating agents. Such fiber treating agents contain the polyalkylene glycol-based graft polymer (or polyalkylene glycol-based graft polymer composition) and at least one selected from the group consisting of dyeing agents, peroxides, and surfactants. In fiber treating agents, the polyalkylene glycol-based graft polymer preferably constitutes 1% to 100% by weight, and more preferably 5% to 100% by weight of the total amount. In addition, any suitable water soluble polymer may be included within a range of not affecting the performance or effect of this polymer. An example of the composition of such a fiber treating agent is described below. The fiber treating agent can be used in steps of scouring, dyeing, bleaching and soaping in fiber treatment. Examples of dyeing agents, peroxides, and surfactants include those commonly used in fiber treating agents.

The blending ratio between the polyalkylene glycol-based graft polymer and at least one selected from the group consisting of dyeing agents, peroxides, and surfactants is determined based on the amount of the purity converted fiber treating agent per part by weight of the polymer. In a suitable example of a composition that is used as a fiber treating agent to provide improved degree of whiteness, color uniformity, and dyeing fastness of textiles, at least one selected from the group consisting of dyeing agents, peroxides, and surfactants is preferably used at a ratio of from 0.1 parts to 100 parts by weight per part by weight of the polyalkylene glycol-based graft polymer.

The fiber treating agent can be used for any suitable fibers including cellulosic fibers such as cotton and hemp, synthetic fibers such as nylon and polyester, animal fibers such as wool and silk thread, semi-synthetic fibers such as rayon, and textiles and mixed products of these. For a fiber treating agent used in a scouring step, an alkali agent and a surfactant are preferably used with the polyalkylene glycol-based graft polymer. For a fiber treating agent used in a bleaching step, a peroxide and a silicic acid-containing agent such as sodium silicate as a decomposition inhibitor for alkaline bleaches are preferably used with the polyalkylene glycol-based graft polymer.

### Detergent Builder

The polyalkylene glycol-based graft polymer (or polyalkylene glycol-based graft polymer composition) can be also used as a detergent builder. The detergent builder can be added to detergents for various usages such as detergents for clothes, tableware, cleaning, hair, bodies, toothbrushing, and vehicles.

### Detergent Composition

The polyalkylene glycol-based graft polymers (or polyalkylene glycol-based graft polymer compositions) described above can be used in detergent compositions. A key advantage of the polyalkylene glycol-based graft polymers is that the polyalkylene oxide backbone is a mixed polyalkylene oxide system providing a plurality of hydrophilicity and hydrophobicity in defined degrees. For example, key examples of the polymer are polymers comprising a main chain involving polyethylene oxide (PEO) capped with a poly- or oligo-propylene oxide moeity on one end, and further comprising acrylic acid graft tentacles grafted onto the main PEO chain.

Without intent to be bound by theory, for such a polymer it is believed the polypropylene oxide (PPO) capping unit provides hydrophobe capping group for PEG/polycarboxylate graft polymers, wherein the degree of hydrophobicity of the capping unit is less than that of simple alkyl or aryl groups. Furthermore, the PPO capping unit may provide a degree of steric bulkiness and hydrogen bond acceptor properties useful for soil, fabric, and surfactant interactions.

In one mode of interaction, the polycarboxylate moieties can bind to calcium, either in solution or as bridging units between clay platelets, with the PEO-PPO backbone extended into water solution and terminally interacting with surfactant monomers or micelles. In another mode of interaction, the PPO capping groups anchor the polymer onto soil, fabric, or surfactant micelle surfaces, with the PEG/polycarboxylate main chain acting to provide charge stabilization to provide a fabric with negative charges (presented to bulk solution) which act as soil repellancy motifs, or to increase the suspendability of clay and other particulate matter via charge stabilization mechanisms.

In detergent compositions, the amount of the polyalkylene glycol-based graft polymer is not particularly limited, and the polyalkylene glycol-based graft polymer is preferably used at a level of 0.1% to 15% by mass, more preferably 0.3% to 10% by mass, and further more preferably 0.5% to 5% by mass based on 100% by mass of the total amount. At levels within this range, the polyalkylene glycol-based graft polymer provides excellent detergent builder performance.

It is to be understood that the concept of the “detergent compositions” includes detergents used only for specific usages such as bleaching detergent in which the performance delivered by one component is improved, in addition to synthetic detergents of household detergents, detergents for industrial use such as detergents used in the textile industry and hard surface detergents.

When the detergent compositions are in the form of a liquid, the water content of the liquid detergent compositions is preferably 0.1% to 75% by mass, more preferably 0.2% to 70% by mass, further more preferably 0.5% to 65% by mass, still further more preferably 0.7% to 60% by mass, particularly preferably 1% to 55% by mass, and more particularly preferably 1.5% to 50% by mass.

When the detergent compositions are in the form of a liquid, the kaolin turbidity of the detergent compositions is preferably not more than 200 mg/L, more preferably not more than 150 mg/L, further more preferably not more than 120 mg/L, still further more preferably not more than 100 mg/L, and particularly preferably not more than 50 mg/L.

Kaolin turbidity may be measured according to the following method. A uniformly stirred sample (liquid detergent) is charged in 50-mm square cells with a thickness of 10 mm, and bubbles are removed therefrom. Then, the sample is measured for turbidity (kaolin turbidity: mg/L) at 25° C. with a turbidimeter (trade name: NDH2000, product of Nihon Denshoku Industries Co., Ltd.).

The polyalkylene glycol-based graft polymers according to the embodiments described above are outstandingly suitable as soil detachment-promoting additives for cleaning compositions such as laundry detergents, for example. It is of particular advantage that they display the soil-detaching power even at low washing temperatures.

The polyalkylene glycol-based graft polymers according to the embodiments described above can be added to the laundry detergents and cleaning compositions in amounts of generally from 0.05% to 10% by weight, from 0.1% to 15% by weight, preferably from 0.1% to 5% by weight, from 0.3% to 10% by weight, from 0.5% to 5% by weight, and more preferably from 0.25% to 2.5% by weight, based on the weight of the cleaning composition.

In addition, the laundry detergents and cleaning compositions generally comprise surfactants and, if appropriate, other polymers as washing substances, builders, and further customary ingredients, for example cobuilders, complexing agents, bleaches, standardizers, graying inhibitors, dye transfer inhibitors, enzymes and perfumes.

The polyalkylene glycol-based graft polymers described herein may be utilized in laundry detergents or cleaning compositions comprising a surfactant system comprising C₁₀-C₁₆ alkyl benzene sulfonates (LAS) and one or more co-surfactants selected from nonionic, cationic, anionic or mixtures thereof. Alternately, the multi-polymer system may be utilized in laundry detergents or cleaning compositions comprising surfactant systems comprising any anionic surfactant or mixture thereof with nonionic surfactants and/or fatty acids, optionally complemented by zwitterionic or so-called semi-polar surfactants such as the C₁₂-C₁₆ alkyldimethylamine N-oxides can also be used. In other embodiments, the surfactant used can be exclusively anionic or exclusively nonionic. Suitable surfactant levels are from about 0.5% to about 80% by weight of the detergent composition, more typically from about 5% to about 60% by weight.

A preferred class of anionic surfactants are the sodium, potassium and alkanolammonium salts of the C₁₀-C₁₆ alkylbenzenesulfonates which can be prepared by sulfonation (using SO₂ or SO₃) of alkylbenzenes followed by neutralization. Suitable alkylbenzene feedstocks can be made from olefins, paraffins or mixtures thereof using any suitable alkylation scheme, including sulfuric and HF-based processes. Any suitable catalyst may be used for the alkylation, including solid acid catalysts such as DETAL™ solid acid catalyst available commercially from UOP, a Honeywell company. Such solid acid catalysts include DETAL™ DA-114 catalyst and other solid acid catalysts described in patent applications to UOP, Petresa, Huntsman and others. It should be understood and appreciated that, by varying the precise alkylation catalyst, it is possible to widely vary the position of covalent attachment of benzene to an aliphatic hydrocarbon chain. Accordingly alkylbenzene sulfonates useful herein can vary widely in 2-phenyl isomer and/or internal isomer content.

The selection of co-surfactant may be dependent upon the desired benefit. In one embodiment, the co-surfactant is selected as a nonionic surfactant, preferably C₁₂-C₁₈ alkyl ethoxylates. In another embodiment, the co-surfactant is selected as an anionic surfactant, preferably C₁₀-C₁₈ alkyl alkoxy sulfates (AEₓS) wherein x is from 1 to 30. In another embodiment the co-surfactant is selected as a cationic surfactant, preferably dimethyl hydroxyethyl lauryl ammonium chloride. If the surfactant system comprises C₁₀-C₁₅ alkyl benzene sulfonates (LAS), the LAS is used at levels ranging from about 9% to about 25%, or from about 13% to about 25%, or from about 15% to about 23% by weight of the composition.

In one embodiment, the surfactant system may comprise from 0% to about 7%, or from about 0.1% to about 5%, or from about 1% to about 4% by weight of the composition of a co-surfactant selected from a nonionic co-surfactant, cationic co-surfactant, anionic co-surfactant and any mixture thereof.

Non-limiting examples of nonionic co-surfactants include: C₁₂-C₁₈ alkyl ethoxylates, such as, NEODOL® nonionic surfactants from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block alkyl polyamine ethoxylates such as PLURONIC® from BASF; C₁₄-C₂₂ mid-chain branched alcohols, BA, as discussed in U.S. Pat. No. 6,150,322; C₁₄-C₂₂ mid-chain branched alkyl alkoxylates, BAEₓ, wherein x is from 1 to 30, as discussed in U.S. Pat. No. 6,153,577, U.S. Pat. No. 6,020,303 and U.S. Pat. No. 6,093,856; alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408. Also useful herein as nonionic surfactants or co-surfactants are alkoxylated ester surfactants such as those having the formula R¹C(O)O(R²O)ₙR³ wherein R¹ is selected from linear and branched C₆-C₂₂ alkyl or alkylene moieties; R² is selected from C₂H₄ and C₃H₆ moieties and R³ is selected from H, CH₃, C₂H₅ and C₃H₇ moieties; and n has a value between 1 and 20. Such alkoxylated ester surfactants include the fatty methyl ester ethoxylates (MEE) and are well-known in the art; see for example U.S. Pat. No. 6,071,873; U.S. Pat. No. 6,319,887; U.S. Pat. No. 6,384,009; U.S. Pat. No. 5,753,606; WO 01/10391, WO 96/23049.

Non-limiting examples of semi-polar nonionic co-surfactants include: water-soluble amine oxides containing one alkyl moiety of from about 10 to about 18 carbon atoms and 2 moieties selected from the group consisting of alkyl moieties and hydroxyalkyl moieties containing from about 1 to about 3 carbon atoms; water-soluble phosphine oxides containing one alkyl moiety of from about 10 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. No. 4,681,704, and U.S. Pat. No. 4,133,779.

Non-limiting examples of cationic co-surfactants include: the quaternary ammonium surfactants, which can have up to 26 carbon atoms include: alkoxylate quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

Nonlimiting examples of anionic co-surfactants useful herein include: C₁₀-C₂₀ primary, branched chain and random alkyl sulfates (AS); C₁₀-C₁₈ secondary (2,3) alkyl sulfates; C₁₀-C₁₈ alkyl alkoxy sulfates (AEₓS) where x is from 1 to 30; C₁₀-C₁₈ alkyl alkoxy carboxylates comprising from 1 to 5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242 and WO 99/05244; methyl ester sulfonate (MES); and alpha-olefin sulfonate (AOS). Anionic surfactants herein may be used in the form of their sodium, potassium or alkanolamine salts.

In example embodiments, cleaning compositions may comprise polyalkylene glycol-based graft polymers according to the embodiments described above, and also a surfactant system comprising C₈-C₁₈ linear alkyl sulphonate surfactant and a co-surfactant. The compositions can be in any form, namely, in the form of a liquid; a solid such as a powder, granules, agglomerate, paste, tablet, pouches, bar, gel; an emulsion; types delivered in dual-compartment containers; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a consumer; and other homogeneous or multiphase consumer cleaning product forms. The composition may alternatively be in the form of a tablet or pouch, including multi-compartment pouches.

In one embodiment, the cleaning composition may be a liquid or solid laundry detergent composition. In another embodiment, the cleaning composition may be a hard surface cleaning composition, preferably wherein the hard surface cleaning composition impregnates a nonwoven substrate. As used herein “impregnate” means that the hard surface cleaning composition is placed in contact with a nonwoven substrate such that at least a portion of the nonwoven substrate is penetrated by the hard surface cleaning composition, preferably the hard surface cleaning composition saturates the nonwoven substrate. The cleaning composition may also be utilized in car care compositions, for cleaning various surfaces such as hard wood, tile, ceramic, plastic, leather, metal, glass. This cleaning composition could be also designed to be used in a personal care and pet care compositions such as shampoo composition, body wash, liquid or solid soap and other cleaning composition in which surfactant comes into contact with free hardness and in all compositions that require hardness tolerant surfactant system, such as oil drilling compositions.

In another embodiment the cleaning composition is a dish cleaning composition, such as liquid hand dishwashing compositions, solid automatic dishwashing compositions, liquid automatic dishwashing compositions, and tab/unit dose forms of automatic dishwashing compositions.

Quite typically, cleaning compositions herein such as laundry detergents, laundry detergent additives, hard surface cleaners, synthetic and soap-based laundry bars, fabric softeners and fabric treatment liquids, solids and treatment articles of all kinds will require several adjuncts, though certain simply formulated products, such as bleach additives, may require only, for example, an oxygen bleaching agent and a surfactant as described herein. A comprehensive list of suitable laundry or cleaning adjunct materials can be found in WO 99/05242.

Common cleaning adjuncts include builders, enzymes, polymers not discussed above, bleaches, bleach activators, catalytic materials and the like excluding any materials already defined hereinabove. Other cleaning adjuncts herein can include suds boosters, suds suppressors (antifoams) and the like, diverse active ingredients or specialized materials such as dispersant polymers (e.g., from BASF Corp. or Rohm & Haas) other than those described above, color speckles, silvercare, anti-tarnish and/or anti-corrosion agents, dyes, fillers, germicides, alkalinity sources, hydrotropes, anti-oxidants, enzyme stabilizing agents, pro-perfumes, perfumes, solubilizing agents, carriers, processing aids, pigments, and, for liquid formulations, solvents, chelating agents, dye transfer inhibiting agents, dispersants, brighteners, suds suppressors, dyes, structure elasticizing agents, fabric softeners, anti-abrasion agents, hydrotropes, processing aids, and other fabric care agents, surface and skin care agents. Suitable examples of such other cleaning adjuncts and levels of use are found in U.S. Pat. Nos. 5,576,282, 6,306,812 B1 and 6,326,348 B1.

### Methods of Use

Further embodiments may include a method for cleaning a targeted surface. As used herein “targeted surface” may include such surfaces such as fabric, dishes, glasses, and other cooking surfaces, hard surfaces, hair or skin. As used herein “hard surface” includes hard surfaces being found in a typical home such as hard wood, tile, ceramic, plastic, leather, metal, glass. Such method includes the steps of contacting the composition comprising the modified polyol compound, in neat form or diluted in wash liquor, with at least a portion of a targeted surface then optionally rinsing the targeted surface. Preferably the targeted surface is subjected to a washing step prior to the aforementioned optional rinsing step. As used herein, “washing” includes, but is not limited to, scrubbing, wiping and mechanical agitation.

As will be appreciated by one skilled in the art, the cleaning compositions described above are ideally suited for use in home care (hard surface cleaning compositions) and/or laundry applications.

The composition solution pH is chosen to be the most complimentary to a target surface to be cleaned spanning broad range of pH, from about 5 to about 11. For personal care such as skin and hair cleaning pH of such composition preferably has a pH from about 5 to about 8 for laundry cleaning compositions pH of from about 8 to about 10. The compositions are preferably employed at concentrations of from about 200 ppm to about 10,000 ppm in solution. The water temperatures preferably range from about 5° C. to about 100° C.

For use in laundry cleaning compositions, the compositions are preferably employed at concentrations from about 200 ppm to about 10,000 ppm in solution (or wash liquor). The water temperatures preferably range from about 5° C. to about 60° C. The water to fabric ratio is preferably from about 1:1 to about 20:1.

The method may include the step of contacting a nonwoven substrate impregnated with an embodiment of the polymers or polymer compositions described herein. As used herein “nonwoven substrate” can comprise any conventionally fashioned nonwoven sheet or web having suitable basis weight, caliper (thickness), absorbency and strength characteristics. Examples of suitable commercially available nonwoven substrates include those marketed under the tradename SONTARA® by DuPont and POLYWEB® by James River Corp.

As will be appreciated by one skilled in the art, the cleaning compositions are ideally suited for use in liquid dish cleaning compositions. The method for using a liquid dish composition comprises the steps of contacting soiled dishes with an effective amount, typically from about 0.5 mL to about 20 mL (per 25 dishes being treated) of the liquid dish cleaning composition diluted in water.

Though particular embodiments of the present invention have been illustrated and described, it will be obvious to those skilled in the art that various other changes and modifications can be made without departing from the spirit and scope of the invention. It is therefore intended to cover in the appended claims all such changes and modifications that are within the scope of this invention.

### EXAMPLES

Hereinafter, the present invention is described in more detail based on examples. It will be understood that these Examples are meant to be illustrative only and not limiting with respect to the scope of the claims. All parts are by weight unless otherwise specified, and all percentages are by mass unless otherwise specified.

The weight average molecular weight of the polyalkylene glycol-based graft polymer of the present invention, the solids contents of polymer compositions and polymerization aqueous solutions, and the yield of the polyalkylene glycol-based graft polymer are determined by the methods shown below.

Weight-Average Molecular Weights (M_{w}) are determined by a technique such as gel-permeation chromatography (GPC) under the following measurement conditions:

Measuring device: L-7000 series (product of Hitachi Ltd.)

Detector: HITACHI RI Detector, L-7490

Column: SHODEX Asahipak GF-310-HQ, GF-710-HQ, GF-1G 7B (products of Showa Denko K. K.)

Column temperature: 40° C.

Flow velocity 0.5 mL/min

Calibration curve: POLYETHYLENE GLYCOL STANDARD (product of GL Sciences, Inc.)

Eluant: 0.1 N sodium acetate/acetonitrile=3:1 (mass ratio).

The carboxyl group-containing monomer and other compounds are quantified by liquid chromatography under the following conditions:

Measuring device: L-7000 series (product of Hitachi Ltd.)

Detector: UV detector, L-7400 (product of Hitachi Ltd.)

Column: SHODEX RSpak DE-413 (product of Showa Denko K. K.)

Temperature: 40.0° C.

Eluant: 0.1% phosphoric acid aqueous solution

Flow velocity: 1.0 ml/min

Solids content of polymer compositions are determined by drying a polymer composition (polymer composition (1.0 g)+water (3.0 g)) in an oven heated to 130° C. in nitrogen atmosphere for one hour. The solids content (%) and volatile component content (%) are calculated from the weight change before and after the drying step.

Yield of the polyalkylene glycol-based graft polymers is defined as the polyalkylene glycol-based graft polymer content (% by mass) of the polymer composition (based on solids content). Thus, the yield is the ratio of the mass of the polyalkylene glycol-based graft polymer contained in the polymer composition to the mass of the solids content of the polymer composition. The polyalkylene glycol-based graft polymer content of the polymer composition is calculated by the following formula, in which all values are expressed as mass percentages based on the total mass of the polymer composition, as derived from the solids content of the polymer composition:

G=100−(U+A_{M}+C+A_{P}),

where G is the polyalkylene glycol-based graft polymer content of the polymer composition, based on the determined solids content; U is the mass percent of unreacted polyoxyalkylene glycol-based compound in the polymer composition; A_{M} is the mass percent of acid group-containing unsaturated monomer in the polymer composition, based on solids content; C is the total mass percent of compound (1), (2) and (3) in the solid matter of the polymer composition, based on solids content; and A_{P} is the mass percent of polymer made of only acid group-containing unsaturated monomer in the polymer composition, based on solids content.

Polymers made of only acid group-containing unsaturated monomers are quantified by capillary electrophoresis under the following conditions:

Measuring device: CAPILLARY ELECTROPHORESIS SYSTEM CAPI-3300 (product of Photal OTSUKA ELECTRONICS)

Voltage: 15 kV

Developing solvent: 50 mmol/L sodium 4-borate aqueous solution

Electrophoresis run time: 30 minutes

Detector: UV 210 nm.

### Example 1

In a 500-mL glass separable flask equipped with a stirrer (paddle blade), ethylene oxide (20-mol adduct of propylene oxide—5-mol adduct of methanol) (86.0 g) is charged and stirred with nitrogen flowing into the flask while heating to 120° C. The flask is kept 120° C. and stirred with nitrogen flowing for one hour to dehydrate the reaction system. Next, a reflux condenser is attached to the flask and the reaction system is heated to 135° C. To the reaction system, 100% acrylic acid (hereinafter, also referred to as “AA”) (9.6 g), and tert-butylperoxy isopropyl monocarbonate (hereinafter, also referred to as PBI) (525 μL; 0.48 g; 5.0% by mass to AA) as a polymerization initiator are separately added drop-wise through different nozzles. The drop-wise addition times of PBI and AA are both 260 minutes. The addition of AA is started 10 minutes after the start of addition of PBI. Each solution is continuously added drop-wise at a constant rate.

After the completion of drop-wise addition of AA, the reaction liquid is maintained (matured) at 135° C. for an additional 60 minutes, and the polymerization is completed (polyalkylene glycol-based graft polymer (1)). After the completion of polymerization, the polymerization reaction liquid is cooled under stirring while pure water (24.0 g) is added to dilute the polymerization reaction liquid.

Thus, an 80% aqueous solution (solids concentration (mass)) (polymer composition (1)) is provided.

### Example 2

In a 500-mL glass separable flask equipped with a stirrer (paddle blade), ethylene oxide (20-mol adduct of propylene oxide—5-mol adduct of methanol) (75.6 g) is charged and stirred with nitrogen flowing into the flask while heating to 120° C. The flask is kept 120° C. and stirred with nitrogen flowing for one hour to dehydrate the reaction system. Next, a reflux condenser is attached to the flask and the reaction system is heated to 135° C. To the reaction system, AA (8.4 g) and PBI (525 μL; 0.42 g; 5.0% by mass to AA) as a polymerization initiator are separately added drop-wise through different nozzles. The drop-wise addition times of PBI and AA are both 210 minutes. The addition of AA is started 20 minutes after the start of addition of PBI. Each solution is continuously added drop-wise at a constant rate.

After the completion of drop-wise addition of AA, the reaction liquid is maintained (matured) at 135° C. for an additional 60 minutes, and the polymerization is completed (polyalkylene glycol-based graft polymer (2)). After the completion of polymerization, the polymerization reaction liquid is cooled under stirring while pure water (21.1 g) is added to dilute the polymerization reaction liquid.

Thus, an 80% aqueous solution (solids concentration (mass)) (polymer composition (2)) is provided.

### Example 3

In a 500-mL glass separable flask equipped with a stirrer (paddle blade), ethylene oxide (20-mol adduct of propylene oxide-5-mol adduct of methanol) (114.7 g) is charged and stirred with nitrogen flowing into the flask while heating to 120° C. The flask is kept 120° C. and stirred with nitrogen flowing for one hour to dehydrate the reaction system. Next, a reflux condenser is attached to the flask and the reaction system is heated to 135° C. To the reaction system, AA (28.7 g) and PBI (1575 μL; 0.42 g; 5.0% by mass to AA) as a polymerization initiator are separately added drop-wise through different nozzles. The drop-wise addition times of PBI and AA are both 210 minutes. The addition of AA is started 20 minutes after the start of addition of PBI. Each solution is continuously added drop-wise at a constant rate.

After the completion of drop-wise addition of AA, the reaction liquid is maintained (matured) at 135° C. for an additional 60 minutes, and the polymerization is completed (polyalkylene glycol-based graft polymer (3)). After the completion of polymerization, the polymerization reaction liquid is cooled under stirring while pure water (36.2 g) is added to dilute the polymerization reaction liquid.

Thus, an 80% aqueous solution (solids concentration (mass)) (polymer composition (3)) is provided.

### Example 4

In a 500-mL glass separable flask equipped with a stirrer (paddle blade), ethylene oxide (30-mol adduct of propylene oxide—5-mol adduct of methanol) (75.6 g) is charged and stirred with nitrogen flowing into the flask while heating to 120° C. The flask is kept 120° C. and stirred with nitrogen flowing for one hour to dehydrate the reaction system. Next, a reflux condenser is attached to the flask and the reaction system is heated to 135° C. To the reaction system, AA (8.4 g) and tert-butylperoxy benzoate (hereinafter, also referred to as PBZ) (525 μL; 0.42 g; 5.0% by mass to AA) as a polymerization initiator are separately added drop-wise through different nozzles. The drop-wise addition times of PBZ and AA are both 210 minutes. The addition of AA is started 20 minutes after the start of addition of PBZ. Each solution is continuously added drop-wise at a constant rate.

After the completion of drop-wise addition of AA, the reaction liquid is maintained (matured) at 135° C. for an additional 60 minutes, and the polymerization is completed (polyalkylene glycol-based graft polymer (4)). After the completion of polymerization, the polymerization reaction liquid is cooled under stirring, while pure water (21.1 g) is added to dilute the polymerization reaction liquid.

Thus, an 80% aqueous solution (solids concentration (mass)) (polymer composition (4)) is provided.

### Example 5

In a 500-mL glass separable flask equipped with a stirrer (paddle blade), ethylene oxide (30-mol adduct of propylene oxide—10-mol adduct of methanol) (75.6 g) is charged and stirred with nitrogen flowing into the flask while heating to 120° C. The flask is kept 120° C. and stirred with nitrogen flowing for one hour to dehydrate the reaction system. Next, a reflux condenser is attached to the flask and the reaction system is heated to 135° C. To the reaction system, AA (8.4 g) and PBI (525 μL; 0.42 g; 5.0% by mass to AA) as a polymerization initiator are separately added drop-wise through different nozzles. The drop-wise addition times of PBI and AA are both 210 minutes. The addition of AA is started 20 minutes after the start of addition of PBI. Each solution is continuously added drop-wise at a constant rate.

After the completion of drop-wise addition of AA, the reaction liquid is maintained (matured) at 135° C. for an additional 60 minutes, and the polymerization is completed (polyalkylene glycol-based graft polymer (5)). After the completion of polymerization, the polymerization reaction liquid is cooled under stirring while pure water (21.1 g) is added to dilute the polymerization reaction liquid.

Thus, an 80% aqueous solution (solids concentration (mass)) (polymer composition (5)) is provided.

### Comparative Example 1

In a 500-mL glass separable flask equipped with a stirrer (paddle blade), ethylene oxide 25 mol adduct of methanol (105.6 g) was stirred with nitrogen flowing into the flask while heating to 120° C. The flask was kept 120° C. and stirred with nitrogen flowing for one hour to dehydrate the reaction system. Next, a reflux condenser was attached to the flask and the reaction system was heated to 128° C. To the reaction system, AA (11.7 g) and PBI (1125 μL; 1.17 g; 10.0% by mass to AA) as a polymerization initiator were separately added drop-wise through different nozzles. The drop-wise addition times of PBI and AA were 150 minutes and 240 minutes, respectively. The addition of AA was started 20 minutes after the start of addition of PBI. Each solution was continuously added dropwise at a constant rate.

After the completion of drop-wise addition of AA, the reaction liquid was maintained (matured) at 128° C. for an additional 60 minutes, and the polymerization was completed to form polyalkylene glycol-based comparative polymer (1). After the completion of polymerization, the polymerization reaction liquid was cooled under stirring while pure water (13.2 g) was added to dilute the polymerization reaction liquid. Thus, a 90% aqueous solution (solids concentration (mass)) (comparative polymer composition (1)) was provided.

### Copolymer Characterizations

The copolymer compositions (1) to (5) were analyzed by liquid chromatography to determine the amounts of the residual monomers, and the results revealed that the total amount of the residual monomers was less than 100 ppm in each composition.

Compatibility with Surfactant

The polymer compositions (1) to (5) prepared in Examples 1 to 5 and the comparative polymer composition (1) prepared in Comparative Example (1) were evaluated as follows. Table 1 shows the results.

Detergent compositions each containing a test sample (polymer or polymer composition) are prepared using the following materials:

SFT-70H (polyoxyethylene alkyl ether, product of NIPPON SHOKUBAI Co., Ltd.): 40 g

NEOPELEX F-65 (sodium dodecylbenzene sulfonate, product of Kao Corp.): 7.7 g (active ingredient: 5 g)

Kohtamin 86W (stearyl trimethylammonium chloride, product of Kao Corp.): 17.9 g (active ingredient: 5 g)

Diethanolamine: 5 g

Ethanol: 5 g

Propylene glycol: 5 g

Test sample: 1.5 g (based on solids content)

Ion exchange water: balance to provide 100 g of detergent composition.

The mixture is sufficiently stirred so that all the components are uniformly dispersed. Turbidity (kaolin turbidity, mg/L) of the mixture is evaluated by turbidity measured at 25° C. with a turbidimeter (“NDH2000”, product of Nippon Denshoku Co., Ltd.).

The evaluation summarized in TABLE 1 is based on the following criteria:

Good: Kaolin turbidity of not less than 0 and less than 50 mg/L; phase separation, sedimentation, and turbidity were not visually observed.

Intermediate: Kaolin turbidity of not less than 50 mg/L and less than 200 mg/L; slight turbidity was visually observed.

Bad: Kaolin turbidity of not less than 200 mg/L; turbidity was visually observed.

TABLE 1
Surfactant compatibility of example copolymers

| | | | | | | Surfactant |
|---|---|---|---|---|---|---|
| Example | Polymer | PO | EO | PEG/Acid | M_{W} | Compatibility |
| Example 1 | copolymer | 5 | 20 | 90/10 | 1700 | Good |
| | (1) | | | | | |
| Example 2 | copolymer | 5 | 20 | 90/10 | 2000 | Good |
| | (2) | | | | | |
| Example 3 | copolymer | 5 | 20 | 80/20 | 3200 | Good |
| | (3) | | | | | |
| Example 4 | copolymer | 5 | 30 | 90/10 | 2200 | Good |
| | (4) | | | | | |
| Example 5 | copolymer | 10 | 30 | 90/10 | 2400 | Good |
| | (5) | | | | | |
| Comparative | comparative | 0 | 25 | 90/10 | 1900 | Good |
| Example 1 | polymer (1) | | | | | |

### Anti-Soil Redeposition Ability Test

Anti-soil redposition ability is tested by the following procedure using JIS Z8901 Test

Powders I Class 11 (typical analysis, 34.0-40.0 wt. % SiO₂, 26.0-32.0 wt. % Al₂O₃, 3.0-7.0 wt. % MgO, 17.0-23.0% Fe₂O₃, 0.0-3.0 wt. % CaO, 0.0-4.0 wt. % TiO₂, with particle sizes from less than 1 μm to about 8 μm):

(1) New white cotton cloth (Bleached, mercerized Cotton Twill as per ISO Doc 509 Series 6, Part 1, available from Testfabrics, Inc, 415 Delaware Avenue, PO Box # 26, West Pittiston, Pa. 18643, USA), is cut into 5 cm×5 cm white cloths. The degree of whiteness is determined for the white cloths by measuring the reflectance with a colorimetric color difference meter (SE2000, product of Nippon Denshoku Industries Co., Ltd.).

(2) Deionized water (20 L) is added to calcium chloride dihydrate (5.88 g) such that hard water is prepared.

(3) Deionized water (100 mL) is added to sodium linear alkylbenzene sulfonate (8.0 g), sodium bicarbonate (9.5 g), and sodium sulfate (8.0 g) such that a surfactant aqueous solution is prepared. The pH is adjusted to 10.

(4) A terg-o-tometer (available from S. R. Lab Instruments, G-16, M. K. Industrial Premises Co-Op. Soc., Sonawala “X” Road No.2, Goregaon (East), Mumbai-400 063 Maharashtra, India) is set at 25° C. Hard water (2 L), the surfactant aqueous solution (5 mL), 0.8% (based on solids content) test polymer aqueous solution (5 g), zeolite (0.30 g), and JIS test powders I Class 11 (1.0 g) (Japanese Industrial Standard powders, available from The Association of Powder Process Industry and Engineering, Kyoto JAPAN) are mixed, and are added to and stirred for one minute in each terg-o-tometer pot at 100 rpm. Subsequently, seven white cloths are put into each pot, and the mixture plus cloths are stirred for ten minutes at 100 rpm.

(5) Rinse Step. The original above mentioned wash water is discarded, the white cloths are wringed by hand, the cloths are returned into each terg-o-tometer pot, and then fresh hard water (2 L) at 25° C. is poured into each terg-o-tometer pot and stirred at 100 rpm for two minutes.

(6) The white clothes are ironed (at approximately 200° C.) with a cloth thereon to dry them while wrinkles are smoothed. The clothes are measured again for reflectance as whiteness with the colorimetric difference meter.

(7) The anti-soil redeposition ratio is determined from the following formula, based on the measurement results. Anti-soil redeposition ratio (%)=(whiteness of white cloth after washed)/(whiteness of original white cloth) x 100. Data for selected copolymers are provided in TABLE 2.

TABLE 2
Anti-soil redeposition ratio of selected example copolymers

| | | Anti-Soil Redeposition |
|---|---|---|
| Example | Polymer | Ability (%) |
| Example 1 | copolymer (1) | 68.2 |
| Example 2 | copolymer (2) | 69.3 |
| Example 3 | copolymer (3) | 70.2 |
| Example 4 | copolymer (4) | 66.6 |
| Example 5 | copolymer (5) | 68.8 |
| Comparative Example 1 | comparative | 51.4 |
| | polymer (1) | |

The results in TABLES 1 and 2 show high compatibility with surfactants and high anti-soil redeposition ability of the polyalkylene glycol-based polymers and therefore suggest that the polyalkylene glycol-based polymers can be suitably used as a raw material for detergent additives and the like.

### Composition Formulations

### Example 6

### Granular Laundry Detergent

Examples of granular laundry detergents including the exemplified amphoteric polymers are provided in TABLE 3.

TABLE 3
Granular Laundry Detergent Compositions

| | A | B | C | D | E |
|---|---|---|---|---|---|
| Formula | wt. % | wt. % | wt. % | wt. % | wt. % |
| C₁₁₋₁₂ Linear alkyl benzene | 13-25 | 13-25 | 13-25 | 13-25 | 9-25 |
| sulphonate | | | | | |
| C₁₂₋₁₈ Ethoxylate Sulfate | — | — | 0-3 | — | 0-1 |
| C₁₄₋₁₅ alkyl ethoxylate (EO = 7) | 0-3 | 0-3 | — | 0-5 | 0-3 |
| Dimethyl hydroxyethyl lauryl ammonium chloride 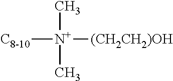 | — | — | 0-2 | 0-2 | 0-2 |
| Sodium tripolyphosphate | 0-40 | — | 5-33 | 0-22 | 0-15 |
| Zeolite | 0-10 | 20-40 | 0-3 | — | — |
| Silicate builder | 0-10 | 0-10 | 0-10 | 0-10 | 0-10 |
| Carbonate | 0-30 | 0-30 | 0-30 | 5-25 | 0-20 |
| Diethylene triamine penta | 0-1 | 0-1 | 0-1 | 0-1 | 0-1 |
| acetate | | | | | |
| Polyacrylate | 0-3 | 0-3 | 0-3 | 0-3 | 0-3 |
| Carboxy Methyl Cellulose | 0.2-0.8 | 0.2-0.8 | 0.2-0.8 | 0.2-0.8 | 0.2-0.8 |
| Polymer¹ | 0.05-10 | 0.05-10 | 5.0 | 2.5 | 1.0 |
| Percarbonate | 0-10 | 0-10 | 0-10 | 0-10 | 0-10 |
| Nonanoyloxybenzenesulfonate | — | — | 0-2 | 0-2 | 0-2 |
| Tetraacetylethylenediamine | — | — | 0-0.6 | 0-0.6 | 0-0.6 |
| Zinc Phthalocyanine | — | — | 0-0.005 | 0-0.005 | 0-0.005 |
| Tetrasulfonate | | | | | |
| Brightener | 0.05-0.2 | 0.05-0.2 | 0.05-0.2 | 0.05-0.2 | 0.05-0.2 |
| MgSO₄ | — | — | 0-0.5 | 0-0.5 | 0-0.5 |
| Enzymes | 0-0.5 | 0-0.5 | 0-0.5 | 0-0.5 | 0-0.5 |
| Minors (perfume, dyes, suds | balance | balance | balance | balance | balance |
| stabilizers) | | | | | |

¹A polyalkylene glycol-based graft polymer according to any of Examples 1-5, or a mixture containing two or more amphoteric polymers according to Examples 1-5.

### Example 7

### Liquid Laundry Detergents

Examples of liquid laundry detergent formulations comprising amphoteric polymers are provided in TABLES 4, 5, and 6.

TABLE 4
Liquid Laundry detergent formulations A-E

| | A | B | C | D | E |
|---|---|---|---|---|---|
| Ingredient | wt. % | wt. % | wt. % | wt. % | wt. % |
| Sodium alkyl ether | 14.4% | — | 9.2% | 5.4% | — |
| sulfate | | | | | |
| Linear alkylbenzene | 4.4% | 12.2% | 5.7% | 1.3% | — |
| sulfonic acid | | | | | |
| Alkyl ethoxylate | 2.2% | 8.8% | 8.1% | 3.4% | — |
| Amine oxide | 0.7% | 1.5% | — | — | — |
| Citric acid | 2.0% | 3.4% | 1.9% | 1.0% | 1.6% |
| Fatty acid | 3.0% | 8.3% | — | — | 16.0% |
| Protease | 1.0% | 0.7% | 1.0% | — | 2.5% |
| Amylase | 0.2% | 0.2% | — | — | 0.3% |
| Lipase | — | — | 0.2% | — | — |
| Borax | 1.5% | 2.4% | 2.9% | — | — |
| Calcium and sodium | 0.2% | — | — | — | — |
| formate | | | | | |
| Formic acid | — | — | — | — | 1.1% |
| Polymer¹ | 1.8% | 2.1% | — | — | 3.2% |
| Sodium polyacrylate | — | — | — | 0.2% | — |
| Sodium polyacrylate | — | — | 0.6% | — | — |
| copolymer | | | | | |
| DTPA² | 0.1% | — | — | — | 0.9% |
| DTPMP³ | — | 0.3% | — | — | — |
| EDTA⁴ | — | — | — | 0.1% | — |
| Fluorescent whitening | 0.15% | 0.2% | 0.12% | 0.12% | 0.2% |
| agent | | | | | |
| Ethanol | 2.5% | 1.4% | 1.5% | — | — |
| Propanediol | 6.6% | 4.9% | 4.0% | | 15.7% |
| Sorbitol | — | — | 4.0% | — | — |
| Ethanolamine | 1.5% | 0.8% | 0.1% | — | 11.0% |
| Sodium hydroxide | 3.0% | 4.9% | 1.9% | 1.0% | — |
| Sodium cumene | — | 2.0% | — | — | — |
| sulfonate | | | | | |
| Silicone suds | — | 0.01% | — | — | — |
| suppressor | | | | | |
| Perfume | 0.3% | 0.7% | 0.3% | 0.4% | 0.6% |
| Opacifier⁵ | — | 0.30% | 0.20% | — | 0.50% |
| Water | balance | balance | balance | balance | balance |
| | 100.0% | 100.0% | 100.0% | 100.0% | 100.0% |

¹A polyalkylene glycol-based graft polymer according to any of Examples 1-5, or a mixture containing two or more amphoteric polymers according to Examples 1-5.
²diethylenetriaminepentaacetic acid, sodium salt
³diethylenetriaminepentakismethylenephosphonic acid, sodium salt
⁴ethylenediaminetetraacetic acid, sodium salt
⁵Acusol OP 301

TABLE 5
Liquid Laundry detergent formulations F-K

| | F | G | H | I | J | K |
|---|---|---|---|---|---|---|
| Ingredient | wt. % | wt. % | wt. % | wt. % | wt. % | wt. % |
| Alkylbenzene sulfonic acid | 7 | 7 | 4.5 | 1.2 | 1.5 | 12.5 |
| Sodium C₁₂₋₁₄ alkyl ethoxy 3 | 2.3 | 2.3 | 4.5 | 4.5 | 7 | 18 |
| sulfate | | | | | | |
| C₁₄₋₁₅ alkyl 8-ethoxylate | 5 | 5 | 2.5 | 2.6 | 4.5 | 4 |
| C₁₂ alkyl dimethyl amine | — | 2 | — | — | — | — |
| oxide | | | | | | |
| C₁₂₋₁₄ alkyl hydroxyethyl | — | — | — | 0.5 | — | — |
| dimethyl ammonium chloride | | | | | | |
| C₁₂₋₁₈ Fatty acid | 2.6 | 3 | 4 | 2.6 | 2.8 | 11 |
| Citric acid | 2.6 | 2 | 1.5 | 2 | 2.5 | 3.5 |
| Protease enzyme | 0.5 | 0.5 | 0.6 | 0.3 | 0.5 | 2 |
| Amylase enzyme | 0.1 | 0.1 | 0.15 | — | 0.05 | 0.5 |
| Mannanase enzyme | 0.05 | — | 0.05 | — | — | 0.1 |
| Alkoxylated | 1.0 | 0 | 1 | 0.4 | 1.5 | 2.7 |
| Polyalkylenimine Polymer or | | | | | | |
| alkoxylated amine polymer | | | | | | |
| Polymer¹ | 0.5 | 1 | 1.5 | 2 | 1 | 0.8 |
| Diethylenetriamine- | 0.2 | 0.3 | — | — | 0.2 | — |
| penta(methylenephosphonic) | | | | | | |
| acid | | | | | | |
| Hydroxyethane diphosphonic | — | — | 0.45 | — | — | 1.5 |
| acid | | | | | | |
| FWA | 0.1 | 0.1 | 0.1 | — | — | 0.2 |
| Solvents (1,2 propanediol, | 3 | 4 | 1.5 | 1.5 | 2 | 4.3 |
| ethanol), stabilizers | | | | | | |
| Hydrogenated castor oil | 0.4 | 0.3 | 0.3 | 0.1 | 0.3 | — |
| derivative structurant | | | | | | |
| Boric acid | 1.5 | 2 | 2 | 1.5 | 1.5 | 0.5 |
| Na formate | — | — | — | 1 | — | — |
| Reversible protease inhibitor³ | — | — | 0.002 | — | — | — |
| Perfume | 0.5 | 0.7 | 0.5 | 0.5 | 0.8 | 1.5 |

| | |
|---|---|
| Buffers (sodium hydroxide, | To pH 8.2 |
| Monoethanolamine) | |
| Water and minors (antifoam, | To 100 |
| aesthetics, . . .) | |

¹A polyalkylene glycol-based graft polymer according to any of Examples 1-5, or a mixture containing two or more amphoteric polymers according to Examples 1-5.

TABLE 6
Liquid Laundry Detergent Formulations L-Q

| | L | M | N | O | P | Q |
|---|---|---|---|---|---|---|
| Ingredient | wt. % | wt. % | wt. % | wt. % | wt. % | wt. % |
| Alkylbenzene sulfonic acid | 5.5 | 2.7 | 2.2 | 12.2 | 5.2 | 5.2 |
| Sodium C₁₂₋₁₄ alkyl ethoxy 3 | 16.5 | 20 | 9.5 | 7.7 | 1.8 | 1.8 |
| sulfate | | | | | | |
| Sodium C₁₂₋₁₄ alkyl sulfate | 8.9 | 6.5 | 2.9 | — | — | — |
| C₁₂₋₁₄ alkyl 7-ethoxylate | — | — | — | — | 0.15 | 0.15 |
| C₁₄₋₁₅ alkyl 8-ethoxylate | — | — | — | — | 3.5 | 3.5 |
| C₁₂₋₁₅ alkyl 9-ethoxylate | 1.7 | 0.8 | 0.3 | 18.1 | — | — |
| C₁₂₋₁₈ Fatty acid | 2.2 | 2.0 | — | 1.3 | 2.6 | 2.6 |
| Citric acid | 3.5 | 3.8 | 2.2 | 2.4 | 2.5 | 2.5 |
| Protease enzyme | 1.7 | 1.4 | 0.4 | — | 0.5 | 0.5 |
| Amylase enzyme | 0.4 | 0.3 | — | — | 0.1 | 0.1 |
| Mannanase enzyme | — | — | — | — | 0.04 | 0.04 |
| Alkoxylated | 2.1 | 1.2 | 1.0 | 2 | 1.00 | 0.25 |
| Polyalkylenimine Polymer or | | | | | | |
| alkoxylated amine polymer | | | | | | |
| Polymer¹ | 0.5 | 1 | 1.5 | 3.0 | 1 | 0.8 |
| PEG-PVAc Polymer² | — | — | — | — | — | 0.3 |
| Ethoxysulfated | — | — | — | — | 1 | 0.7 |
| Hexamethylene Diamine | | | | | | |
| Dimethyl Quat | | | | | | |
| Diethylenetriaminepenta | — | — | — | — | 0.2 | 0.2 |
| (methylenephosphonic)acid | | | | | | |
| FWA | — | — | — | — | .04 | .04 |
| Solvents (1,2 propanediol, | 7 | 7.2 | 3.6 | 3.7 | 1.9 | 1.9 |
| ethanol, stabilizers | | | | | | |
| Hydrogenated castor oil | 0.3 | 0.2 | 0.2 | 0.2 | 0.35 | 0.35 |
| derivative structurant | | | | | | |
| Polyacrylate | — | — | — | 0.1 | — | — |
| Polyacrylate copolymer³ | — | — | — | 0.5 | — | — |
| Sodium carbonate | — | — | — | 0.3 | — | — |
| Sodium silicate | — | — | — | — | — | — |
| Borax | 3 | 3 | 2 | 1.3 | — | — |
| Boric acid | 1.5 | 2 | 2 | 1.5 | 1.5 | 1.5 |
| Perfume | 0.5 | 0.5 | 0.5 | 0.8 | 0.5 | 0.5 |
| Buffers (sodium hydroxide, | — | — | — | — | 3.3 | 3.3 |
| monoethanolamine) | | | | | | |

| | |
|---|---|
| Water, dyes and | Balance |
| miscellaneous | |

¹A polyalkylene glycol-based graft polymer according to any of Examples 1-5, or a mixture containing two or more amphoteric polymers according to Examples 1-5.
²PEG-PVA graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units.
³Alco 725 (styrene/acrylate)

### Example 8

### Liquid Dish Handwashing Detergents

Example liquid dish handwashing detergent formulations are provided in TABLE 7.

TABLE 7
Liquid Dish Handwashing Detergent Formulations

| Composition | A | B |
|---|---|---|
| C₁₂₋₁₃ Natural AE_{0.6}S | 29.0 | 29.0 |
| C₁₀₋₁₄ mid-branched Amine Oxide | — | 6.0 |
| C₁₂₋₁₄ Linear Amine Oxide | 6.0 | — |
| SAFOL ® 23 Amine Oxide | 1.0 | 1.0 |
| C₁₁E₉ Nonionic² | 2.0 | 2.0 |
| Ethanol | 4.5 | 4.5 |
| Polymer¹ | 5.0 | 1.0 |
| Sodium cumene sulfonate | 1.6 | 1.6 |
| Polypropylene glycol 2000 | 0.8 | 0.8 |
| NaCl | 0.8 | 0.8 |
| 1,3 BAC Diamine³ | 0.5 | 0.5 |
| Suds boosting polymer⁴ | 0.2 | 0.2 |
| Water | Balance | Balance |

¹A polyalkylene glycol-based graft polymer according to any of Examples 1-5, or a mixture containing two or more amphoteric polymers according to Examples 1-5.
²Nonionic may be either C₁₁ Alkyl ethoxylated surfactant containing 9 ethoxy groups.
³1,3 BAC is 1,3 bis(methylamine)-cyclohexane.
⁴(N,N-dimethylamino)ethyl methacrylate homopolymer

### Example 9

### Automatic Dishwasher Detergent

Example automatic dishwasher detergent formulations are provided in TABLE 8.

TABLE 8
Automatic Dishwasher Detergent Formulations

| | A | B | C | D | E |
|---|---|---|---|---|---|
| Polymer dispersant² | 0.5 | 5 | 6 | 5 | 5 |
| Carbonate | 35 | 40 | 40 | 35-40 | 35-40 |
| Sodium | 0 | 6 | 10 | 0-10 | 0-10 |
| tripolyphosphate | | | | | |
| Silicate solids | 6 | 6 | 6 | 6 | 6 |
| Bleach and bleach | 4 | 4 | 4 | 4 | 4 |
| activators | | | | | |
| Polymer¹ | 0.05-10 | 1 | 2.5 | 5 | 10 |
| Enzymes | 0.3-0.6 | 0.3-0.6 | 0.3-0.6 | 0.3-0.6 | 0.3-0.6 |
| Disodium citrate | 0 | 0 | 0 | 2-20 | 0 |
| dihydrate | | | | | |
| Nonionic surfactant³ | 0 | 0 | 0 | 0 | 0.8-5 |
| Water, sulfate, | Balance | Balance to | Balance | Balance | Balance |
| perfume, dyes and | to 100% | 100% | to 100% | to 100% | to 100% |
| other adjuncts | | | | | |

¹A polyalkylene glycol-based graft polymer according to any of Examples 1-5, or a mixture containing two or more amphoteric polymers according to Examples 1-5.
²Such as ACUSOL ® 445N available from Rohm & Haas or ALCOSPERSE ® from Alco.
³Such as SLF-18 POLY TERGENT from the Olin Corporation.

### Example 10

Liquid laundry detergent composition in the form of a pouch, being encapsulated by a film of polyvinyl alcohol.

Example Liquid laundry detergent compositions in pouchs are provided in TABLE 9.

TABLE 9
Encapsulated Liquid Laundry Detergent Formulations

| | | B | | |
|---|---|---|---|---|
| | | 3 compartments | | |
| | A | pouched product | | |
| Compartment # | 1 | 1 | 2 | 3 |
| Dosage (g) | 36.0 | 34.0 | 3.5 | 3.5 |
| Ingredients | wt. % | wt. % | wt. % | wt. % |
| Alkylbenzene sulfonic acid | 14.5 | 14.5 | 20.0 | — |
| C₁₂₋₁₄ alkyl ethoxy 3 sulfate | 8.5 | 8.5 | — | — |
| C₁₂₋₁₄ alkyl 7-ethoxylate | 12.5 | 12.5 | 17.0 | — |
| C₁₂₋₁₈ Fatty acid | 14.5 | 14.5 | 13.0 | — |
| Protease enzyme | 1.5 | 1.5 | — | — |
| Amylase enzyme | 0.2 | — | — | — |
| Mannanase enzyme | 0.1 | — | — | — |
| PAP granule¹ | — | — | — | 50.0 |
| Polymer² | 1.5 | 2.0 | — | — |
| Ethoxysulfated Hexamethylene Diamine | 3.0 | — | 2.2 | — |
| Dimethyl Quat | | | | |
| PEG-PVAc Polymer³ | — | — | 2.5 | — |
| Hydroxyethane diphosphonic acid | 1.0 | 0.6 | 0.6 | — |
| Brightener | 0.2 | 0.2 | 0.2 | — |
| Solvents (1,2 propanediol, ethanol), | 20 | 20 | 25 | 30.0 |
| stabilizers | | | | |
| Hydrogenated castor oil derivative | 0.1 | — | 0.05 | — |
| structurant | | | | |
| Perfume | 1.8 | 1.7 | — | — |

| | |
|---|---|
| Buffers (sodium | To pH 8.0 for liquid |
| hydroxide, monoethanolamine) | |
| Water and minors (antioxidant, | To 100% |
| aesthetics, . . .) | |

¹PAP = Phthaloyl-Amino-Peroxycaproic acid, as a 70% active wet cake
¹A polyalkylene glycol-based graft polymer according to any of Examples 1-5, or a mixture containing two or more amphoteric polymers according to Examples 1-5.
³PEG-PVA graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ”

“Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.”

“While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.”

All documents cited in the Detailed Description of the Invention are incorporated herein by reference. The citation of any document is not to be construed as an admission that it is prior art with respect to the present invention.

Unless otherwise defined, all technical and scientific terms used herein have the same meaning as commonly understood by one of ordinary skill in the art to which the invention belongs. The terminology used in the description herein is for describing particular embodiments only and is not intended to be limiting.

As used in the specification and appended claims, the singular forms “a,” “an,” and “the” are intended to include the plural forms as well, unless the context clearly indicates otherwise.

The term “independently selected from,” as used in the specification and appended claims, is intended to mean that the referenced groups can be the same, different, or a mixture thereof, unless the context clearly indicates otherwise. Thus, under this definition, the phrase “X¹, X², and X³ are independently selected from the group consisting of A, B, and C” would include the scenario where X¹, X², and X³ are all the same, where X¹, X², and X³ are all different, and where X¹ and X² are the same but X³ is different.

Though particular embodiments have been illustrated and described, it will be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition comprising a polyalkylene glycol-based graft polymer, the polyalkylene glycol-based graft polymer being obtained by polymerizing in a polymerization mixture:
a polyalkylene glycol-based compound having formula (II):
R²Y—X_{P}—Z_{q}—OR¹)ᵣ (II),
where:
each R¹ is independently selected from the group consisting of —H, a C₆₋₂₀ aryl group, a linear or branched C₁₋₂₀ alkyl group, and a linear or branched C₁₋₂₀ alkenyl group;
R² is selected from the group consisting of —H, a C₆₋₂₀ aryl group, a linear or branched C₁₋₂₀ alkyl group, and a C₁₋₂₀ linear or branched alkenyl group;
r is an integer from 1 to 6 and represents the number of groups —Y—XₚZ_{q}—OR¹ attached to a single group R²;
each Y is selected from the group consisting of —O—R³—, —S—R⁴—, 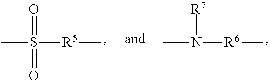
where:
αR³ to R⁶ are independently selected from a C₂₋₆ alkylene group,
R⁷ is —H or a group having formula (III):
—R⁸—Z_{q}—R⁹ (III)
where R⁸ is a C₂₋₆ alkylene group
R⁹ is —H, a C₆₋₂₀ aryl group, a C₁₋₂₀ alkyl group, or a C₁₋₂₀ alkenyl group; and
Z and q are defined as in formula (II);
each X is —C(═O)— or 1,4-phenylene;
p is 0 or 1;
each Z is an oxyalkylene group;
q is from 9 to 150 and represents an average addition number of moles of oxyalkylene groups;
Z_{q} represents a structure having formula (IV):
Z²₁Z¹ₙZ²ₘ (IV)
where:
each Z¹ is independently selected from C₃₋₄ oxyalkylene groups;
each Z² is independently selected from C₂₋₂₀ oxyalkylene groups;
n is from 3 to 30 and represents an average addition number of moles of C₃₋₄ oxyalkylene groups (—Z¹—);
m is 0, 1, 2, or 3; and
l+n+m=q; and
a monomer material comprising at least one carboxyl group-containing monomer, the polymerization mixture comprising from 60% to 95% by mass of the polyalkylene glycol-based compound and from 5% to 40% by mass of the at least one carboxyl group-containing monomer, based on the total mass of the polyalkylene glycol-based compound and the monomer material in the polymerization mixture.

2. The cleaning composition of claim 1, wherein R² is methyl or ethyl.

3. The cleaning composition of claim 1, wherein R¹ and R² both are —H and r is 1.

4. The cleaning composition of claim 1, wherein R¹ and R² both are —H and m is 0.

5. The cleaning composition of claim 1, wherein each group Z¹ is an oxypropylene group

6. The cleaning composition of claim 1, wherein:
each group Z¹ in the polyalkylene glycol-based compound is an oxypropylene group; and
each group Z has an oxyethylene ratio of at least 50 mol. %.

7. The cleaning composition of claim 1, wherein:
p is 0;
r is 1;
Y is —O—R³—;
R³ is oxyethylene;
each group Z¹ in the polyalkylene glycol-based compound is an oxypropylene group; and
each group Z has an oxyethylene ratio of at least 80 mol. %.

8. The cleaning composition of claim 1, wherein each carboxyl group-containing monomer is selected from the group consisting of acrylic acid, maleic acid, salts of any of these, derivatives of any of these, and mixtures of any of these.

9. The cleaning composition of claim 1, wherein the monomer material further comprises at least one additional monomer not classified as a carboxyl group-containing monomer.

10. The cleaning composition of claim 9, wherein the at least one additional monomer is selected from the group consisting of sulfonic acid group-containing monomers, amino group-containing monomers, allylamine monomers, quaternized allylamine monomers, N-vinyl monomers, hydroxyl group-containing monomers, vinylaryl monomers, isobutylene monomers, vinyl acetate monomers, salts of any of these, derivatives of any of these, and mixtures thereof.

11. The cleaning composition of claim 1, wherein the polyalkylene glycol-based graft polymer has a weight-average molecular weight of from 300 to 50,000.

12. The cleaning composition of claim 1, wherein the cleaning composition is selected from the group consisting of liquid laundry detergent compositions, solid laundry detergent compositions, hard surface cleaning compositions, liquid hand dishwashing compositions, solid automatic dishwashing compositions, liquid automatic dishwashing compositions, tab or unit-dose form automatic dishwashing compositions contained within a water-soluble pouch, and laundry detergent compositions contained within a water-soluble pouch.

13. The cleaning composition of claim 1, wherein the cleaning composition comprises from about 0.05% by weight to about 10% by weight of the polyalkylene glycol-based graft polymer, based on the total weight of the cleaning composition.

14. The cleaning composition of claim 1, further comprising a surfactant system.

15. The cleaning composition of claim 14, wherein the surfactant system comprises at least one C₁₀-C₁₆ alkyl benzene sulfonate surfactant.

16. The cleaning composition of claim 15, wherein the surfactant system further comprises one or more co-surfactant selected from the group consisting of nonionic surfactants, cationic surfactants, anionic surfactants, and mixtures thereof.

17. The cleaning composition of claim 14, wherein the surfactant system comprises at least one C₈-C₁₈ linear alkyl sulfonate surfactant.

18. The cleaning composition of claim 15, wherein the surfactant system further comprises one or more co-surfactant selected from the group consisting of nonionic surfactants, cationic surfactants, anionic surfactants, and mixtures thereof.

19. The cleaning composition of claim 18, further comprising one or more cleaning adjunct additives.

20. A cleaning implement comprising a nonwoven substrate and a cleaning composition according to claim 1.
